(19) United States
(12) Patent Application Publication
(10) Pub. No.: US 2024/0377045 A1
(43) Pub. Date: Nov. 14, 2024

(54) OPTICAL FILTER AND LIGHTING UNIT COMPRISING THE SAME

(71) Applicants: CoeLux S.r.l., Lomazzo (CO) (IT); UNIVERSITA’ DEGLI STUDI DELL'INSUBRIA, Varese (IT)

(72) Inventor: Paolo Di Trapani, Cavallasca (IT)

(21) Appl. No.: 18/689,559

(22) PCT Filed: Sep. 13, 2021
(86) PCT No.: PCT/IB2021/058316

§ 371 Date: Mar. 6, 2024

(51) Int. Cl. F21V 9/40; G02B 5/22

(52) U.S. Cl. CPC F21V 9/40; G02B 5/22

(57) ABSTRACT

An optical filter is described comprising a first surface and a second surface which are substantially flat and parallel to each other; a plurality of optically transparent channels, parallel to each other, and made of at least one solid material, each channel having: an elongated conformation along a longitudinal axis and extending between said first surface and said second surface; and a respective side surface; each channel comprising at least one central core having a first refractive index; a first cladding which wraps the outer side surface of said central core and having a second refractive index lower than said first refractive index; a first optically absorbing material interposed between the side surface of adjacent channels and configured to reduce the passage of light through adjacent channels; wherein each channel has a length L along said longitudinal axis which satisfies the following relationship L<AL₀: where formula (I) ηₐ is the value of said first refractive index, R is an average channel radius of the plurality of channels, θ₀ is a cut-off angle of the filter and A is a constant equal to 5.

### TECHNICAL FIELD

The present invention generally relates to an optical filter. Furthermore, the present invention relates to a lighting unit, in particular, to a lighting unit of artificial light and/or of natural light simulating natural sunlight, which makes use of such an optical filter.

### BACKGROUND

As is well known, the main characteristics of natural light on a clear day, which distinguish it from artificial light of lamps, are linked to the ability to:
(i) produce an image of the sun perceived by the eye of the observer at an infinite distance;
(ii) produce the image of a round sun;
(iii) produce sharp shadows, thanks to the highly directional characteristic of the sunlight, which has a divergence of only 0.5 degrees;
(iv) produce blue shadows, as they are illuminated by sky light whose colour correlated temperature—CCT—is much higher than the colour correlated temperature of sunlight;
(v) produce bright shadows, i.e. with a luminance typically not less than 15-20% of the characteristic luminance of the surfaces exposed to both sky and sunlight;
(vi) produce the image of a clear cloudless sky and of a sun in sharp contrast to the sky.

The development of a lighting unit capable of producing light identical to natural sunlight, i.e. a light with the above characteristics, has not been achieved to date. In particular, the development of a lighting unit capable of producing artificial light and/or natural light analogous to the natural sunlight, entails costs that make it difficult to market any resulting product.

In fact, the Applicant has noted that in order to produce an image of the sun in the eye at infinite distance (feature (i)) it is necessary that the luminance profile of the light is spatially uniform across the observation surface. This condition is necessary to allow two eyes of an observer to see the same image, providing the brain with information about an object at a substantially infinite distance.

Furthermore, in order to ensure the image of a sun in sharp contrast to a cloudless sky (feature (vi)), it is necessary that the angular luminance profile from the sunlight cancels out for a given value of a polar angle equal to a cut-off angle, i.e. it assumes substantially values equal to zero for polar angles greater than a cut-off angle, this polar angle being the angle with respect to the direction for which the angular luminance profile exhibits the maximum value. In addition, to achieve better realism it is useful that the angular luminance profile from sunlight exhibit maximum contrast for polar angles around the cut-off angle, i.e. it exhibits a sharp jump in the luminance value near a cut-off angle. Furthermore, an even better realism can be obtained in the case of an angular luminance profile similar to a flat-top profile, characterised by a substantially constant luminance value for angles smaller than a cut-off angle, i.e. within an angular acceptance cone, and substantially equal to zero elsewhere.

In fact, the Applicant has noted that the eye associates the presence in the sky of clouds or haze with an angular luminance profile of the standard bell-shaped type (e.g. Gaussian), i.e. without a cut-off angle. Disadvantageously, this feature is not popular with the market, as it compromises the ability of the lighting unit to evoke the experience of a clear day.

Finally, in order to guarantee the image of a round sun (feature (ii)), it is necessary that the angular luminance profile from sunlight is substantially independent or not very dependent on the azimuthal angle.

An optical filter theoretically capable of producing a spatially uniform luminance over a given surface, and at the same time producing a substantially constant angular luminance profile for polar angles lower than a cut-off angle, i.e. within an angular acceptance cone, is the micro-optical tandem mixer, hereinafter more simply “tandem mixer” considered by the Applicant in the lighting unit described in WO 2020/201938. As is well known, such an optical filter consists of two matrices of identical lenses (or micro-lenses), one facing the other, and arranged at a distance equal to the common focal length. This optical filter produces the uniformly illuminated image of the lens aperture in the far field, and therefore also on the retina in the case of infinity vision. Therefore, provided the lenses are circular and uniformly illuminated, which is not difficult to achieve in the case of very small-sized lenses, it produces an angular profile of substantially constant luminance within an angular acceptance cone.

Disadvantageously, the tandem mixer used in WO 2020/201938 presents some significant problems in practice:
it reproduces on the retina, in addition to the main image, also one or more uniformly illuminated secondary or ghost images, having a shape substantially similar to the main image (although typically less bright than the main image);
in order to ensure maximum construction simplicity and maximum brightness, the lens matrices that compose it are made up of square, rectangular or hexagonal lenses, or in any case with a shape that allows maximum compaction and therefore maximum coverage of the input and output surfaces. As a result, the image they produce on the retina is not circular but square, or rectangular, or hexagonal etc.

In summary, a lighting unit using a tandem mixer as described in WO 2020/201938 would produce the main image of a square (or rectangular, or hexagonal) sun surrounded by ghost images identical to the main image except for being less intense.

As described in WO 2020/201938, in order to eliminate the problem of the secondary images, it was considered to introduce, downstream of the tandem mixer, a spatial filter obtained by means of a matrix of empty parallel channels made from absorbing walls (e.g. organised according to a honeycomb structure). Disadvantageously, such a spatial filter introduces high losses, as only 50% of the rays entering the filter at angles smaller than the geometric cut-off angle of the filter exit without being absorbed, causing high losses or low transmission efficiency. In addition, the inevitable low-angle diffusion that the rays experience when they meet the absorbing wall coming from the air produces stray light that reduces the contrast and having spatial modulation of the filter, so that the filter exhibits an undesirable regular pattern in the luminance profile that can be easily perceived by the observer.

Disadvantageously, in order to remove the regular pattern in the luminance profile above it is necessary to introduce an additional filter, i.e., a low-angle diffuser filter downstream thereof. Significantly, such a low-angle diffuser also has the purpose of mitigating the second mentioned problem of the tandem mixer, in that it allows the image of an object positioned beyond it to be blurred, the further away the object is, thus turning the images of squares, rectangles, hexagons etc. into circles. However, disadvantageously, a low-angle diffuser filter produces an angular luminance profile characterised by Gaussian type tails, i.e. without a sharp cut-off angle.

### BRIEF DESCRIPTION OF THE INVENTION

The object of the present invention is to provide an optical filter that overcomes the above problems. A further object of the present invention is to provide an optical filter which, once used in a lighting unit simulating natural sunlight, is capable of generating an image indefinitely of a sun with well-defined contours. Another object of the present invention is to provide a lighting unit reproducing an image of a circular sun. Yet another object is to provide an optical filter which, once used in a lighting unit simulating natural sunlight, makes the use of low-angle diffuser filters downstream the optical filter unnecessary, allowing the sharp contrast between the image of the sun and the one of the sky to be preserved. Not least, an object of the present invention is to realise a lighting unit simulating natural sunlight which is capable of providing an image indefinitely of a circular sun with well-defined contours. A still further object of the present invention is to realise a lighting unit simulating natural sunlight that can provide an image indefinitely of a sun in sharp contrast to a cloudless sky. A further object of the present invention is to provide an optical filter which, once used in a lighting unit of artificial light and/or of natural light simulating natural sunlight, is capable of generating an image indefinitely of a sun with well-defined contours. Yet another object of the present invention is to realise a lighting unit of artificial light simulating natural sunlight which is able to offer an image indefinitely of a circular sun with well-defined contours. Last but not least, a further object of the present invention is to realise a lighting unit of natural light simulating natural sunlight capable of providing an image indefinitely of a circular sun with well-defined contours.

These and other purposes of the present invention are achieved by an optical filter for lighting devices that simulate natural sunlight incorporating the features of the appended claims, which form an integral part of the present description.

According to a first aspect, the present invention provides an optical filter comprising:
a first substantially flat surface and a second substantially flat surface parallel to the first surface;
a plurality of optically transparent channels, parallel to each other, and made of at least one solid material; and
a first optically absorbing material interposed between the side surface of adjacent channels,
wherein said first optically absorbing material is configured to reduce the passage of light through adjacent channels.

Each channel has an elongated conformation along a longitudinal axis and extends between the first surface and the second surface. Each channel has a respective side surface.

Each channel further comprises at least:
a central core having a first refractive index; and
a first cladding, which wraps the outer side surface of the central core having a second refractive index lower than the first refractive index.

Again, each channel has a length (L) along the longitudinal axis that satisfies the following relationship:

$$L < {AL}_{0}$$

$$where$$

$${L}_{0} ≡ 2 \frac{{n}_{a} R}{tan ( a s i n \frac{sin {θ}_{0}}{{n}_{a}} )}$$

and where nₐ is the value of the first refractive index, θ₀ is a cut-off angle of the filter, R is the average channel radius of the plurality of channels and A is a constant equal to 5, or preferably equal to 3, or more preferably equal to 2, or even more preferably equal to 1.5, or even more preferably equal to 1.3.

For small values of the cut-off angle θ₀, i.e. θ₀<10°, the aforesaid relationship can be approximated as follows

$${L}_{0} ≡ 2 \frac{{n}_{a} R}{{θ}_{0}}$$

In this description and in the attached claims, the expressions containing the term “average” and “mean”-unless otherwise specified—are intended to indicate the average over the distribution of the plurality of channels.

Specifically, the average channel radius averaged over the plurality of channels is defined by the relationship

$$R ≡ < \frac{\sqrt{{F}_{c} / cos α}}{π} > ,$$

F_{c} being the area of the input or output face of a channel and α being an angle between the longitudinal axis of the channel and the normal to the first or to the second surface.

Specifically, the cut-off angle of the filter θ₀ is the average of the polar angle, measured with respect to the longitudinal axis, such that the angular luminance profile of the filter substantially cancels out (due to the presence of the first optically absorbing material interposed between adjacent channels), i.e. it assumes a value equal to 1/10, preferably 1/20, preferably equal to 1/30 of the peak value, for example in the case in which the filter is illuminated by a diffused light, i.e. by a light with a uniform and isotropic luminance profile, the average being evaluated with respect to the azimuthal angle and over the entire surface of the filter. Alternatively, the cut-off angle of the filter θ₀ is the average over the azimuthal coordinate of the polar angle value so that the luminous intensity profile of the filter substantially cancels out when the filter is illuminated by a diffused light.

Advantageously, the first optically absorbing material interposed between adjacent channels makes it possible to reduce and/or eliminate cross-talk phenomena between adjacent channels of the optical filter.

Advantageously, the first optically absorbing material interposed between adjacent channels makes it possible to reduce and/or eliminate the passage of light between the first and the second surfaces of the filter outside the channels.

The Applicant has advantageously observed that the use of the first optically absorbing material interposed between adjacent channels makes it possible to reduce and/or eliminate the passage of light between adjacent channels as well as between the first and the second surface outside the channels, thus contributing to a θ₀ sharp cut-off angle.

Furthermore, the Applicant has advantageously observed that the use of a solid material for the channels instead of air is able to reduce or remove the low-angle diffusion by the absorbent cladding, thus increasing the contrast and reducing the unwanted visibility of the channels.

Furthermore, the configuration in which each channel comprises at least a central core and a first cladding significantly increases the transmission efficiency of the filter compared to the case of a homogeneous channel, reducing consumptions. In fact, at least some of the rays that would otherwise be absorbed are reflected by total internal reflection (TIR) and enter/exit each channel at angles θ<θ₀.

Furthermore, limiting the length L of the channel at the top to values not much greater than L0—i.e. to the length for which the geometric cut-off angle and the TIR angle of the channel coincide, i.e. the length for which each outgoing ray experiences only one reflection in the channel-makes it possible to minimise the thickness of the filter, e.g. compared to the typical case of filters with guiding channels, and therefore the cost and consumption of raw materials.

The present invention may have at least one of the following preferred features; the latter may in particular be combined with one another as desired in order to meet specific application needs.

Preferably, the average channel radius is lower than 0.5 mm (R<0.5 mm), more preferably lower than 0.2 mm (R<0.2 mm), even more preferably lower than 0.1 mm (R<0.1 mm).

Advantageously, the sub-millimetre or micrometre dimensions of the average channel radius further reduce its visibility, since they are below the visual resolution of the channels.

Preferably, the cut-off angle is comprised between 1°<θ₀<50°, more preferably comprised between 2°<θ₀<20°, even more preferably comprised between 3°<θ₀<10°.

Preferably, in the case of channels comprising only one cladding, the length L of each channel satisfies the following relationship:

$$L > {BL}_{0}$$

where is B is a constant equal to ⅕, preferably equal to ⅓, more preferably equal to ½, even more preferably equal to 1/1.5, even more preferably equal to 1/1.3.

Preferably, each channel comprises a plurality of claddings, each cladding having a respective refractive index. In a preferred configuration, each channel comprises a plurality of at least 3 claddings, preferably of at least 4 claddings, more preferably of at least 5 claddings, and even more preferably of at least 7 claddings.

Preferably, each channel has a discrete refractive index profile; said refractive index profile having a maximum at the volume of said central core and decreasing along a radially outward direction.

Preferably, each channel has a maximum refractive index nₘₐₓ and a minimum refractive index nₘᵢₙ. Said maximum refractive index nₘₐₓ corresponds to said first refractive index of said central core and said minimum refractive index nₘᵢₙ corresponds to a refractive index of the outermost cladding of the channel.

Preferably, said maximum refractive index nₘₐₓ and said minimum refractive index nₘᵢₙ satisfy the following relationship with a tolerance of more or less 50%:

$$\sqrt{{n}_{max}^{2} - {n}_{min}^{2}} ≃ sin ( {θ}_{0} )$$

wherein θ₀ is said cut-off angle of the filter (100).

Advantageously, this condition (equivalent to L≃L₀) further maximises the efficiency, by extending the TIR reflection to all the rays entering the core at angles θ<θ₀. For sufficiently thin thicknesses of the first cladding, transmission coefficients T of the channel significantly greater than 50% are obtained, e.g. T>60%, or T>70% for angles θ<θ₀.

Preferably, the length L also satisfies the following relationship:

$$L < {AL}_{1} ,$$

$$where$$

$${L}_{1} ≡ \frac{π}{2} \frac{{n}_{a} R}{sin {θ}_{0}}$$

and where nₐ is the value of the first refractive index, R is the average channel radius of the plurality of channels, θ₀ is the cut-off angle of the filter and A is a constant equal to 5, or preferably equal to 3, or more preferably equal to 2, or even more preferably equal to 1.5, or even more preferably equal to 1.3.

For small values of the cut-off angle θ₀, i.e. θ₀<10°, the aforesaid relationship can be approximated as follows

$${L}_{1} ≡ \frac{π}{2} \frac{{n}_{a} R}{{θ}_{0}} .$$

Specifically, as the Applicant has verified, L1 is the nominal length that a GRIN (GRaded INdex) fibre with a radial profile of parabolic index, circular section, radius R and index at the centre na, should have in order to produce focal in the medium equal to its length, generate in the far field the image of the input aperture, and in particular create an angular profile of luminous intensity substantially flattop with a cut-off angle θ₀, if uniformly illuminated and covered by an optically absorbent external covering.

Preferably, in the case of channels comprising a plurality of claddings, the length L of each channel satisfies the following relationship:

$$L > {BL}_{1}$$

where B is a constant equal to ⅕, preferably equal to ⅓, more preferably equal to ½, even more preferably equal to 1/1.5, even more preferably equal to 1/1.3.

The Applicant has verified that, in order to achieve a filter with a “sharp cut-off”, or maximum slope, or maximum contrast, a length of the channels shorter than BL₁ results in a reduction in the performance of the filter, e.g. it results in a loss of contrast associated with a reduction in the slope of the angular luminance profile in a neighbourhood of the cut-off angle greater than 30%.

Preferably, each channel has a respective centre corresponding to the point of centre of gravity of a section orthogonal with respect to the longitudinal axis of the respective channel.

In this description and in the appended claims, the term “section” is intended to mean the section in the plane orthogonal to the longitudinal axis.

Preferably, each channel comprises an intermediate cladding, interposed between an innermost cladding or the central core and an adjacent outermost cladding; said intermediate cladding, said innermost cladding and said outermost cladding having a respective refractive index; wherein for a respective channel the following relationship applies:

$$\frac{n ( i - 1 ) - n ( i )}{d ( i ) - d ( i - 1 )} < \frac{n ( i ) - n ( i + 1 )}{d ( i + 1 ) - d ( i )}$$

where:
n(i−1) is the refractive index of said innermost cladding or of said central core,
n(i) is the refractive index of said intermediate cladding,
n(i+1) is the refractive index of the adjacent outermost cladding,
d(i−1) is an average distance from an axis parallel to the longitudinal axis and passing through said centre of the respective channel to a radially outer surface of said innermost cladding or of said central core,
d(i) is an average distance from an axis parallel to the longitudinal axis and passing through said centre of the respective channel to a radially outer surface of said intermediate cladding, and
d(i+1) is an average distance from an axis parallel to the longitudinal axis and passing through said centre of the respective channel to a radially outer surface of said adjacent outermost cladding, where average is intended to mean the average over the azimuthal angle and over a section of the respective channel.

Preferably, the optical filter has an image plane.

Preferably, the optical filter also has an object plane.

In particular, the object plane and/or the image plane is/are placed at a distance D1 from the first surface and/or from the second surface along the direction of the longitudinal axis given by the following relationship:

$${D}_{1} ≃ \frac{2 L}{{n}_{α} π}$$

wherein:
L is the length (L) of a respective channel;
nₐ is the refractive index of the central core.

Advantageously, the use of a plurality of claddings with a decreasing refractive index moving away from the centre of the channel and/or such that the ratio between the variation in index and the variation in the average distance from the centre increases from one cladding to the next one, and/or such that the channel behaves like a GRIN lens or fibre with focal length in air equal to D1 and therefore able to produce an object plane and an image plane that are conjugated to each other and positioned at a distance D1 from the first surface 101 and from the second surface 102 of the filter along the direction of the longitudinal axis, i.e. as it happens for a GRIN lens or fibre with length L having focal in the medium that is positive and equal to L, allows to obtain an optical filter with high efficiency and contrast by further reducing the thickness of the filter with respect to the case of a filter with a single cladding. For example, the use of a plurality of claddings with decreasing refractive indexes moving away from the centre of the channel makes it possible to reduce the length of the optical filter by a ratio of the order of L₀/L₁≃1.3 compared to the case of a single cladding, at the same cut-off angle, without significant losses of efficiency, and with a significant increase in the contrast.

Advantageously, the design of a filter with a discrete index profile allows to greatly simplify the production process and thus to reduces costs compared to the case of a design otherwise based on the use of GRIN fibres with a continuous index profile.

Surprisingly, as the Applicant has verified, all this is possible without significantly compromising the performance. Specifically, the solution subject-matter of the present invention allows the use of multi clad polymeric optical fibres (Polymeric Multi Step Index Optical Fibers), which are much cheaper than quartz or glass GRIN optical fibres, and whose use would be substantially necessary if a continuous index modulation is to be produced. Such polymeric fibres can be obtained for example starting from preforms, such as cylindrical, square, hexagonal preforms and so on, comprising a central preform core and a plurality of claddings having refractive indices as well as average radius and average thicknesses respectively equal to the refractive indices, radius and average thicknesses of the central core and of the claddings of the channels of the optical filter.

Preferably, the object plane and/or the image plane is/are placed at a distance D2 from the first surface and/or from the second surface given by the following relationship:

$${D}_{2} ≃ \frac{2.41 L}{{n}_{a}}$$

wherein:
L is the length of a respective channel;
nₐ is the refractive index of the central core, the longitudinal axis of the filter being further substantially orthogonal to the first and to the second surface.

Advantageously, such a channel behaves like a GRIN lens or fibre with length L with focal in the medium that is positive and equal to 2L. Therefore, by appropriately mirroring one of the input and output surfaces of the filter, it is possible to obtain a filter operating in double step having thickness

$$L ≃ \frac{1}{2} {L}_{1}$$

and performances similar to those of a double-length filter, resulting in further cost and raw material savings.

Preferably, each channel has a constant cross-sectional conformation, hereinafter also referred to as “extruded solid conformation”.

According to some embodiments, each channel has a cylindrical conformation having a substantially circular section. It should be noted that if the longitudinal axis of the filter is inclined with respect to the normal to the first or to the second surface by an angle α other than 0, the shape of the section of each channel can be obtained, for example, by projecting the face of the channel onto the plane orthogonal to the longitudinal axis, i.e. onto the sectional plane.

Advantageously, e.g., in the case of a diffused lighting source, such a channel produces an angular profile of luminous intensity independent of the azimuthal angle, and an optical filter comprising a plurality of such channels produces an angular luminance profile independent of the azimuthal angle, as required in order to reproduce the image of a round sun.

According to other embodiments, each channel has a substantially non-circular section.

According to some embodiments, an average over the plurality of channels of the ratio between radii of the circumferences circumscribed and inscribed to the section of each channel has a value greater than 1.05, preferably greater than 1.2, more preferably greater than 1.3.

In the context of the present description and in the appended claims, the expression “inscribed circumferences” is intended to mean a plurality of inscribed circumferences, wherein each circumference is inscribed in the section of a respective channel.

In the context of the present description and in the appended claims, the expression “circumscribed circumferences” is intended to mean a plurality of circumscribed circumferences, wherein each circumference circumscribes the section of a respective channel.

Preferably, the average of the ratio between the radii of the circumferences circumscribed and inscribed to the section of each channel has a value lower than 3, preferably lower than 2.5, more preferably lower than 2.

According to various embodiments, the optical filter comprises a plurality of channels with a polygonal section. Preferably, the optical filter may comprise a plurality of channels having a regular polygonal section, for example a triangular, square or hexagonal section.

Advantageously, channels with a polygonal section allow for a greater covering or tessellation of the plane than in the case of channels with a circular section, and therefore a greater overall section of channels capable of gathering incident light and a possible greater transmission efficiency.

In alternative embodiments, each channel substantially conforms to an extrusion solid with substantially non-circular section and/or has a central core having a cylindrical shape with a substantially circular section.

Advantageously, this conformation makes it possible to optimise the gathering of light that is incident on the first surface of the filter by the channels. In fact, this conformation allows to optimise the occupation of the surfaces of the filter by the sections of the channels, reducing any possible interspaces to a minimum. However, the substantially circular conformation of the section of the central core, which conveys most of the luminous flux, helps to produce a luminous intensity profile of each channel that is substantially independent or little dependent on the azimuthal coordinate ϕ, in spite of the non-circular, e.g. polygonal shape, of the channel section. This feature contributes positively to the purpose of efficiently producing the image of a circular sun.

According to some embodiments of the invention, the filter comprises a plurality of channels which are different from each other, i.e. characterised by a distribution of sections having areas and/or shapes and/or orientation in the sectional plane that are different from each other. Preferably, each channel has a section with an area and/or shape substantially different from the area and/or shape of the section of at least another channel, respectively.

According to other embodiments, the filter comprises a plurality of channels such that the distribution of the radii of the circumferences inscribed in each section of each channel has a standard deviation greater than 2%, preferably 4%, more preferably 6% of the average value over the same distribution, the sections being in the plane orthogonal to the longitudinal axis.

Preferably, the filter comprises a plurality of channels such that the distribution of the radii of the circumferences inscribed in each section of each channel has a standard deviation of less than 70%, preferably 50%, more preferably 30% of the average value.

According to some embodiments of the invention, the filter comprises a plurality of channels which are different from each other and/or statistically equivalent.

By “statistically equivalent” it is meant that the probability that a channel has a certain characteristic, e.g. a section of certain area, shape, or orientation in the sectional plane, is substantially the same for each channel of the plurality of channels. By way of example, a plurality of statistically equivalent channels produces local average values, such as the average of the areas and/or of the shapes and/or of the orientation of the sections, which are substantially independent of the particular position in the sectional plane, the local average being, for example, defined as the average over a circular area with radius equal to 15 cm, preferably equal to 10 cm, more preferably equal to 5 cm.

Advantageously, the statistical equivalence of the channels results in an invariability of the optical properties of the filter as perceived by an observer with respect to the specific position observed within the filter, regardless of how much the properties of a single channel differ from those of another channel.

Preferably, the plurality of channels is configured such that each of the aforesaid optical properties of each channel is also a locally verified average optical property of the filter. For example, the conjugate object and image planes are also a feature of the filter, being in this case parallel to the first and/or to the second surface, the distances always being measured along the longitudinal axis.

Preferably, the optical filter comprises a plurality of channels such that:
the distribution of the radii of the inscribed circumferences is characterised by a standard deviation greater than 3%, preferably 5%, more preferably 7% of the average value, and
the distribution of a local average of the radii of the plurality of inscribed circumferences is characterised by a standard deviation of less than 5%, preferably 3%, more preferably 1% of the average value over the whole filter, such local average being carried out over an area of the filter comprised in a circle with radius of less than 15 cm, preferably less than 10 cm, more preferably less than 5 cm.

Preferably, the filter comprises a plurality of channels with substantially randomly oriented sections in a plane orthogonal to the longitudinal axis.

In particular, according to some embodiments of the invention, the filter comprises a plurality of channels with substantially non-circular sections and oriented in a substantially random manner such that:
(i) the average of the ratio between the radii of the circumferences circumscribed and inscribed to the section of each channel in a plane with section orthogonal to the longitudinal axis has a value greater than 1.05, preferably greater than 1.2, more preferably greater than 1.3, and
(ii) the locus of points {x,y} in the sectional plane satisfying the relationship F(x, y)>CFₘₐₓ is substantially a circle, i.e. it is a surface delimited by a perimeter where a maximum distance of the perimeter from a centre and a minimum distance of the perimeter from the centre differ from each other by a quantity of less than 30%, preferably 20%, more preferably 10% of an average distance of the perimeter from the centre, where the average is carried out over the perimeter of the channel and where C=0.5, preferably C=0.3, more preferably C=0.2, and where F(x, y) is an obtained function:
(i) translating without rotation in the sectional plane (x,y) all the channel sections so that they are aligned vertically, i.e. along the coordinate y, and horizontally, i.e. along the coordinate x, at a centre, and
(ii) giving F(x, y) a value equal to the number of translated sections comprising the point (x,y).

Advantageously, a filter configuration that provides for a plurality of channels with substantially non-circular and substantially randomly oriented sections allows for greater ease of production and/or greater covering or tessellation than in the case of identical channels with circular section, and thus lower cost and greater transmission efficiency, while at the same time allowing for the production of an angular luminance profile that is on average substantially independent of the azimuthal angle. These average properties of the luminance profile are sufficient to produce in the observer the perception of a round sun. Considering for example channels with average radius R<0.5 mm, R<0.2 mm, more preferably R<0.1 mm, characterised by a cut-off angle θ₀>1°, preferably θ₀>2°, more preferably θ₀>4°, the number of channels participating in forming in the observer at a typical distance from the filter, i.e. at a distance of more than a few tens of centimetres, the image of the sun is higher than several hundreds, thousands, or tens of thousands of units, i.e. sufficient to produce in the observer the perception of the average luminance.

Preferably, each channel has a conformation with constant section or of an extruded solid with a non-polygonal concave or convex section.

Preferably, each channel has a conformation with constant section or of an extruded solid having an irregular polygonal section, i.e. having a section conforming to a non-regular polygon. Still more preferably, each channel has a conformation with constant section or of an extruded solid with an irregular convex polygonal section.

Preferably, the filter comprises a plurality of channels with prism configuration with irregular polygonal sections such that
(i) the average of the ratio between the radii of the circumferences circumscribed and inscribed to the section of each channel in a plane with section orthogonal to the longitudinal axis has a value greater than 1.05, preferably greater than 1.2, more preferably greater than 1.3, and
(ii) the locus of the points {x,y} in the sectional plane satisfying the relationship F(x, y)>CFₘₐₓ is substantially a circle, i.e. it is a surface delimited by a perimeter where a maximum distance of the perimeter from a centre and a minimum distance of the perimeter from the centre differ from each other by a quantity of less than 30%, preferably 20%, more preferably 10% of an average distance of the perimeter from the centre, where the average is carried out over the perimeter of the channel and where C=0.5, preferably C=0.3, more preferably C=0.2, and where F(x, y) is a function obtained by:
(a) translating without rotating in the sectional plane all the channel sections so that they are aligned vertically along the coordinate y and horizontally along the coordinate x at a centre, and
(b) attributing to F(x, y) a value equal to the number of translated sections comprising the point (x,y).

Advantageously, a plurality of channels with prism configuration with a non-regular polygon section and/or where each channel has a polygon section with shape and/or area that is substantially different from the shape and/or the area of another channel, allows for the maximum sectional coverage or tessellation of the plane while allowing the production of an angular profile of average luminance substantially independent of the azimuthal coordinate, provided that the orientation of the polygons is substantially random.

According to a further aspect, the present invention provides a lighting unit.

Preferably, the lighting unit is a lighting unit of artificial light.

The lighting unit of artificial light comprises a direct light source. The direct light source emits visible light non-isotropically and has a first colour correlated temperature or CCT.

Preferably, the direct light source comprises a visible light emitter, an optical system for collimating the light emitted by the visible light emitter and a flat surface for emitting the direct light.

Preferably, the direct light source is configured to generate a light mainly along directions comprised within an emission cone having a directrix of the emission cone perpendicular to the flat surface of direct light emission and having an angular half-opening of direct light, defined as the half-width of the angular luminance profile of the direct light source on the flat emission surface, lower than 50 degrees, preferably lower than 30 degrees, more preferably lower than 10 degrees, where the semi-width is measured at a height equal to 0.5 times the peak value and the angular luminance profile is averaged over the spatial coordinates and the azimuthal coordinated.

The lighting unit of artificial light further comprises an optical filter according to the present invention, positioned downstream of the direct light source such that the first surface 101 of the optical filter is superimposed, at least partially, on the flat surface of emission of the direct light of the direct light source.

Preferably, the lighting unit of artificial light comprises a diffused light source configured to emit a diffused visible light having a second colour correlated temperature or CCT at least 1.2 times, preferably 1.3 times, more preferably 1.5 times, even more preferably 1.8 times greater than the first CCT, and/or than a CCT equal to 5600 Kelvin.

According to an alternative embodiment, the lighting unit of artificial light for reproducing sunlight comprises a direct light source configured to emit visible light non-isotropically having a first colour correlated temperature or CCT, wherein the direct light source comprises a plurality of light sources arranged on a substantially transparent surface, each light source of the plurality of light sources being arranged and configured to generate a beam of light with a profile of source angular luminance having a peak along a same main direction.

According to this alternative embodiment, the lighting unit of artificial light for reproducing sunlight further comprises a chromatic light reflective unit that is substantially planar and with normal substantially parallel to the main direction, said chromatic light reflective unit being positioned in the space such that the light sources of the plurality of light sources illuminate it substantially uniformly.

Preferably, said chromatic light reflective unit comprises a reflective surface oriented towards the direct light source.

Preferably, the chromatic light reflective unit further comprises an optical filter in accordance with the present invention, positioned adjacent to and preferably in contact with the reflective surface.

Preferably, said chromatic light reflective unit further comprises a diffused light source interposed between the optical filter and the direct light source and configured to emit a diffused visible light having a second colour correlated temperature or CCT at least 1.2 times, preferably 1.3 times, more preferably 1.5 times, even more preferably 1.8 times greater than the first CCT, and/or than a CCT equal to 5600 Kelvin.

According to a different aspect, the present invention provides a lighting unit of natural light.

The lighting unit of natural light comprises a receiving surface configured to receive a natural light and an optical filter according to the present invention having the first and/or the second surface at least partially overlapping said receiving surface.

Preferably, the lighting unit of natural light comprises a diffused light source configured to emit a diffused visible light having a colour correlated temperature or CCT at least 1.2 times, preferably 1.3 times, more preferably 1.5 times, even more preferably 1.8 times greater than a CCT of the natural light and/or than a CCT equal to 5600 Kelvin.

### BRIEF DESCRIPTION OF THE DRAWINGS

The invention will become clearer from the following detailed description, which is provided by way of non-limiting example and should be read with reference to the accompanying drawings (not to scale), wherein:

FIG. 1 is a schematic perspective view from above of a first embodiment of an optical filter according to the present invention;

FIG. 2 is a schematic perspective view of a channel according to the present invention;

FIG. 3 is a schematic plan view of a face of a channel used to make the optical filter of FIG. 1.

FIG. 4 is a schematic plan view of a surface of the optical filter according to an embodiment of the present invention;

FIG. 5 is an exemplary graph of the radial profile of the refractive index as a function of the radial distance of an exemplary channel according to the present invention;

FIG. 6 shows a profile of an exemplary light suitable for illuminating a filter according to the present invention;

FIGS. 7a, 7b and 7c show a variation of the profile of a filtered light as a function of the length L of a channel in accordance with the present invention;

FIGS. 8a, 8b and 8c show a variation of the profile of a filtered light as a function of the number of optical claddings wrapping the central core of a channel in accordance with the present invention;

FIG. 9a is a schematic plan view of a surface of the optical filter according to a further embodiment of the present invention;

FIG. 9b shows an image obtained by illuminating the filter shown in FIG. 9a with a diffused light source;

FIG. 9c shows a schematic plan view of a surface of the optical filter according to a further embodiment of the present invention;

FIG. 9d shows an image obtained by illuminating the filter shown in FIG. 9c with a diffused light source;

FIG. 10a is a schematic plan view of a face of a channel used to make an optical filter according to a further embodiment of the present invention;

FIG. 10b is a schematic plan view of a surface of the optical filter according to a further embodiment of the present invention;

FIGS. 11a and 11b are a schematic representation of an exemplary embodiment of, respectively, a light reflective unit and chromatic unit using an optical filter according to the present invention;

FIG. 12 is a schematic perspective view of a lighting unit of artificial light for reproducing sunlight according to the present invention;

FIG. 13 is a schematic perspective view of a first variant of light source used in the lighting unit of artificial light for reproducing sunlight according to the present invention;

FIGS. 14 and 15 are schematic representations of light entering and exiting the components of the lighting unit of artificial light for reproducing sunlight according to the present invention; and

FIG. 16 is a schematic representation of a further lighting unit of artificial light for reproducing sunlight in accordance with the present invention;

FIG. 17 is a schematic representation of a further lighting unit of artificial light for reproducing sunlight in accordance with the present invention;

FIGS. 18a, 18b and 18c are schematic representations of different embodiments of lighting unit of natural lights using the optical filter according to the present invention.

### DETAILED DESCRIPTION OF THE CURRENTLY PREFERRED EMBODIMENTS

The following is a detailed description of exemplary embodiments of the present invention. The exemplary embodiments described herein and illustrated in the drawings are intended to convey the principles of the present invention, allowing the person skilled in the art to implement and use the present invention in numerous different situations and applications. Therefore, the exemplary embodiments are not intended, nor should they be considered, to limit the scope of patent protection. Rather, the scope of patent protection is defined by the attached claims.

For the illustration of the drawings, use is made in the following description of identical numerals or symbols to indicate construction elements with the same function. Moreover, for clarity of illustration, certain references may not be repeated in all drawings.

The use of “for example”, “etc.”, “or” indicates non-exclusive alternatives without limitation unless otherwise indicated. The use of “comprises” and “includes” means “comprises or includes, but not limited to”, unless otherwise indicated.

Furthermore, the use of measures, values, shapes and geometric references (such as perpendicular and parallel) associated with terms such as “approximately”, “almost”, “substantially” or similar, is to be understood as “without measurement errors” or “unless inaccuracies due to manufacturing tolerances” and in any case “less than a slight divergence from the values, measures, shapes or geometric references” with which the term is associated.

In the context of this description and in the appended claims, the terms “optically absorbent” and “optically transparent” is intended to mean the property of a material to absorb or transmit visible radiation, i.e., the optical radiation having wavelengths in the range 380 nm-780 nm.

Finally, terms such as “first”, “second”, “upper”, “lower”, “main” and “secondary” are generally used to distinguish components belonging to the same type, not necessarily implying an order or a priority of relationship or position.

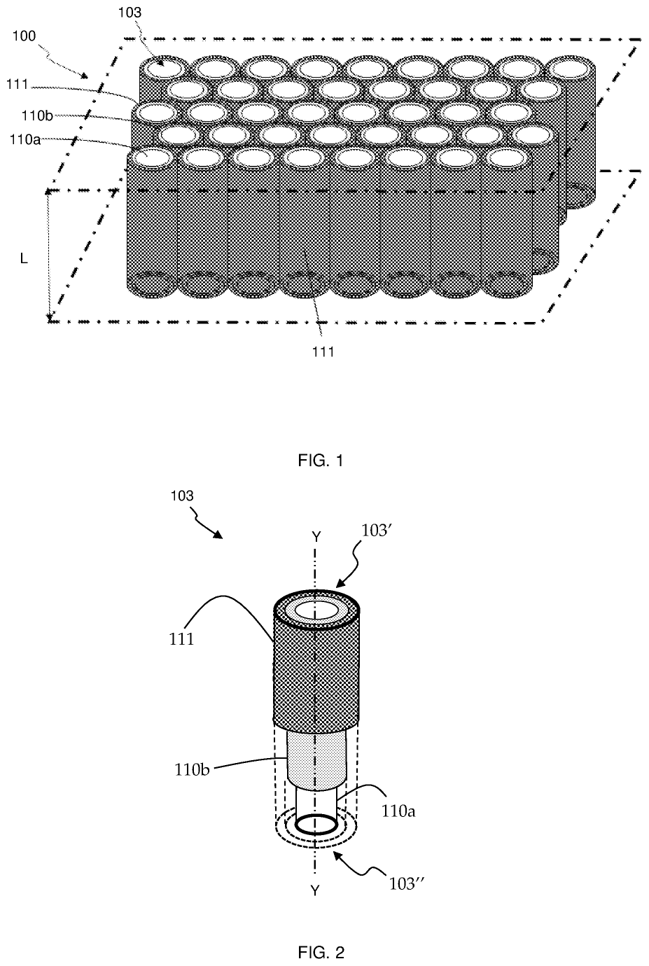

With reference initially to FIG. 1, the present invention provides an optical filter overall referred to as 100. The optical filter 100 comprises a first surface 101 and a second surface 102 that are substantially flat and parallel to each other. The optical filter 100 further comprises a plurality of channels 103. The channels 103 are made of at least one solid material and are substantially transparent to visible light. The channels 103 are parallel to each other.

The term “visible light” refers to a light having a wavelength preferably comprised between 380 nm and 780 nm.

Each channel 103 has a substantially elongated conformation along a longitudinal axis Y-Y. Each channel 103 has: an input face 103′ (e.g., at a first end); an output face 103′ (e.g., at a second end); and an outer side surface.

In the embodiment of FIG. 1, each channel 103 extends between the first surface 101 and the second surface 102 of the optical filter 100, hereinafter also referred to more simply as “filter 100”. For example, each channel 103 has a respective longitudinal development axis Y-Y perpendicular to the first surface 101 and/or to the second surface 102. Alternatively, according to an embodiment not shown in the figures, the longitudinal development axis Y-Y of each channel 103 has an inclination angle α comprised between 5° and 80°, preferably between 10° and 70°, more preferably between 20° and 60° with respect to an axis perpendicular to the first surface 101 and/or to the second surface 102. Preferably, in the case in which an inclination angle as described above is present, the input face 103′ and the output face 103″ of each channel 103 are inclined with respect to a plane orthogonal to the axis Y-Y so as to be parallel to the first surface 101 and to the second surface 102, respectively. In particular, the input face 103′ of each channel 103 lies at the first surface 101 of the filter 100; the output face 103″ of each channel 103 lies at the second surface 102 of the filter 100.

In the embodiments illustrated, each channel 103 has a section, orthogonal to the longitudinal axis Y-Y, which is substantially constant along the longitudinal axis Y-Y, i.e., each channel 103 conforms to an extruded solid. In particular, the section of a respective channel 103 defines an area of the channel 103 (denoted by the symbol Ac) and an effective radius of the channel

$${R}_{c} ≡ \frac{\sqrt{{A}_{c}}}{π} ,$$

where the relationship applies:

$${A}_{c} = {F}_{c} / cos a \qquad [ 1 ]$$

where Fc is the area of the input face 103′ or of the output face 103″ of the channel 103 and α is the inclination angle between the direction of the longitudinal axis Y-Y and the outgoing normal to the first surface 101 or to the second surface 102 of the filter 100.

Preferably, the portion of the first surface 101 and/or of the second surface 102 of the filter 100 overall covered by the input 103′ and output 103″ faces of the channels 103, or OAR (Open Area Ratio), is at least equal to 50%, preferably 60%, more preferably 70%, even more preferably 85% of the total surface of the first surface 101 and/or of the second surface 102.

According to an embodiment of the present invention, the plurality of channels 103 has a distribution of channels 103 that are substantially identical to each other, except for a tolerance interval due to the manufacturing process used.

Alternatively, the plurality of channels 103 has a distribution of channels 103 that are different from each other. Preferably, the plurality of channels 103 defines a distribution of channels that are statistically equivalent to each other. In particular, the plurality of channels 103 is associated with an average channel radius R=<R_{c}>. Preferably, the average radius of the plurality of channels 103 is less than 1 mm, more preferably less than 0.5 mm, even more preferably less than 0.2 mm, further preferably less than 0.1 mm.

According to the present invention, the optical filter 100 has a cut-off angle θ₀. Preferably, the cut-off angle of the filter θ₀ is the average of the polar angle, measured with respect to the longitudinal axis Y-Y, such that the angular luminance profile of the filter 100 substantially cancels out, i.e. it assumes a value equal to 1/10, preferably 1/20, preferably equal to 1/30 of the peak value, e.g., in the case in which the filter is illuminated by a diffused light, i.e. by a light with a uniform and isotropic luminance profile, this average being evaluated with respect to the azimuthal angle and over the whole surface of the filter. Alternatively, the cut-off angle of the filter θ₀ is the average over the azimuthal coordinate of the polar angle value so that the luminous intensity profile of the filter 100 substantially cancels out when the filter 100 is illuminated by a diffused light.

As shown in FIGS. 1-4, 10a and 10b, each channel 103 has a central core 110a and at least a first cladding 110b.

According to the embodiment shown in FIG. 2, each channel 103 comprises a central core 110a having a first refractive index and only one cladding 110b having a second refractive index, the first refractive index being greater than the second refractive index. For example, a channel 103 of this type corresponds to an optical fibre known as a “single-clad fibre”. Alternatively, as shown in FIG. 4, each channel 103 has a central core 110a and a plurality of claddings 110b, . . . , 110d. In other words, each channel 103 is either a “single-clad fibre” or a “multi-clad fibre”.

As shown in FIG. 1-4, the central core 110a preferably has a circular section. In particular, the central core 110a has a cylindrical shape with a circular section and each cladding 110b, . . . , 110d has a conformation characterised by a substantially cylindrical outer surface with circular section.

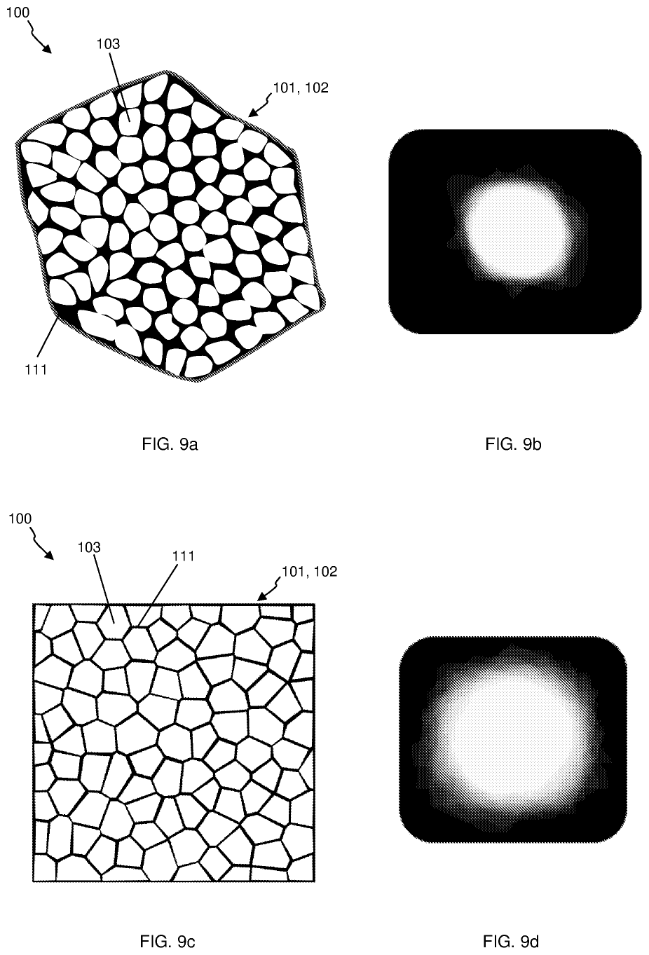

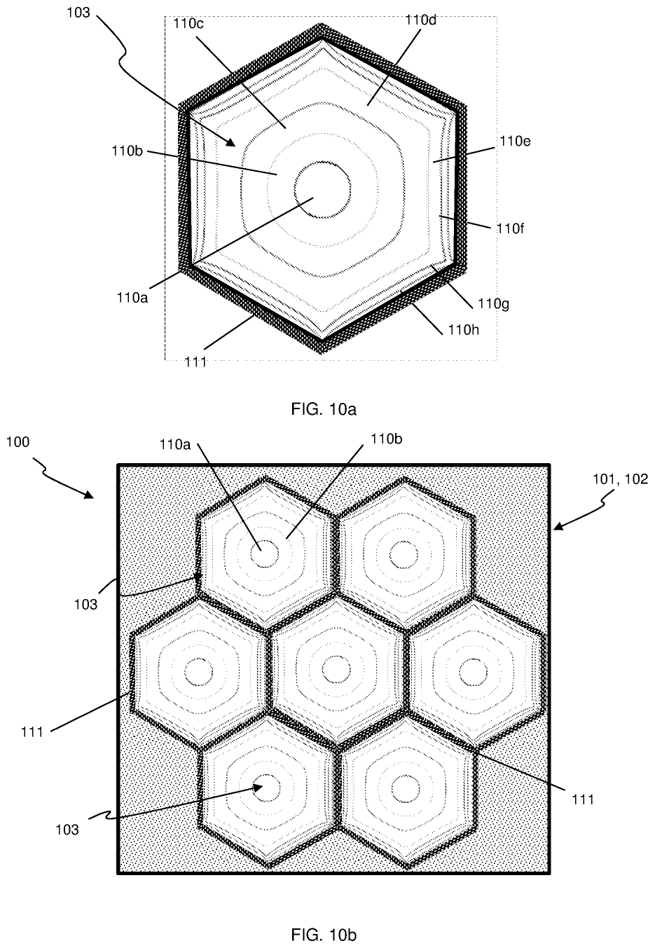

With reference to FIGS. 10a, 10b, 9a and 9c, the central core 110a preferably has a cylindrical shape with a substantially circular section. Preferably, at least one cladding 110b, . . . , 110n has a conformation characterised by an outer surface of extruded solid having a section other than the circular one.

In some particular embodiments, such as the one illustrated in exemplary terms in FIGS. 10a and 10b, the central core 110a and the radially innermost claddings 110b, 110c have conformation characterised by an outer surface of extruded solid and section conforming to a convex figure, while at least some of the radially outermost claddings 110f, 110g, 110h have sections having a certain degree of concavity. In particular, in specific embodiments, the outermost radial cladding 110h has a substantially polygonal section.

With reference specifically to FIG. 10a, the particular conformation of the sections of the central core 110a and of the claddings 110b, . . . 110h of the channel 103 illustrated is obtained by modelling a deformation process of a multi-step cylindrical polymeric fibre having initially core and claddings with outer surfaces conforming to cylinders with circular section. Specifically, this deformation is achieved by heating the fibre to the glass transition temperature(s) of the constituent material(s), and by applying an external force that forces the outermost cladding 110h, and thus the entire channel 103, to assume an outer surface conforming to the outer surface of a hexagonal prism, wherein, moreover, the deformation process occurs while preserving the section area of the central core 110a and of each cladding 110b-110h, and thus the section area of the channel 103. In the process of deformation from the channel, the outermost claddings experience the maximum deformation, while the innermost claddings and particularly the central core experience little or no deformation. Different final conformations of the channels 103, of the central core 110a and of the claddings 110b-110n contained therein, as well as of the outer covering 111 can be obtained by modifying the initial conditions and/or the process parameters, and in particular by applying the external force to a bundle of multi-step polymeric fibres, so as to obtain a bundle of transparent channels embedded in one or more absorbing materials, possibly repeating the process several times if necessary in order to achieve the desired dimensions of the channels. The optical filter is thus obtained by cutting a slice of this bundle of channels at the desired thickness along a plane suitably oriented with respect to the longitudinal axis of the channels.

According to alternative embodiments, the channels 103 conform to an extrusion solid with a substantially non-circular section. In particular, said channels 103 comprise a central core 110a having a cylindrical shape with a substantially circular section. Defining for each channel 103 the quantities η_{c} and ηₐ as

$${{η}_{c} ≡ {ρ}_{circ} / {ρ}_{insc} \vert}_{channel} \qquad [ 2 ]$$

$$and$$

$${{η}_{a} ≡ {ρ}_{circ} / {ρ}_{insc} \vert}_{core}$$

where ρ_{circ}/ρ_{insc}|_{channel} is the ratio between the radii of the circumferences circumscribed and inscribed to the section of a given channel 103, and where ρ_{circ}/ρ_{insc}|_{core} is defined as the ratio between the radii of the circumferences circumscribed and inscribed to the section of the central core 110a of the same channel 103, it is obtained that the average of the ratio between the quantities η_{c} and ηₐ calculated on the plurality of channels is equal to:

$$< {η}_{c} / {η}_{a} > = G \qquad [ 4 ]$$

with G being greater than 3, preferably G being greater than 5, more preferably G being greater than 10.

The central core 110a is preferably made of a material chosen by the group comprising glass, quartz, PMMA, polycarbonate, polystyrene or other polymeric resin.

Each cladding 110a, . . . , 110n is made from a material preferably chosen from the group consisting of glass, quartz, PMMA, polystyrene, polycarbonate, or other polymeric resin, or from a composite material obtained by mixing or co-polymerising polymers or co-polymers with a higher and lower refractive index, the latter being selected for example from those normally used for the claddings of optical fibres (cladding resins), in percentages suitable for obtaining the desired refractive index.

Each channel 103 has an outer covering 111. The outer covering 111 wraps the outer side surface of the respective channel 103. For example, considering the channel 103 shown in FIG. 2, the outer covering 111 wraps the outer side surface of the channel 103. The outer covering 111 is made of a first optically absorbing material. The first optically absorbing material is preferably chosen from the group consisting of glass, quartz, PMMA, polycarbonate, or other polymeric resin in a form made optically absorbent by the addition of light-absorbing components.

Preferably, the absorption coefficient of the first optically absorbing material ensures an absorption of at least 50%, preferably 80%, more preferably 90% of the visible light for a material thickness equal to R/2, preferably equal to R/3, more preferably equal to R/5, where R is the average channel radius described above. For example, the outer covering 111 made from the first optically absorbing material is a jacket that substantially covers the side surface of a respective channel 103, or, is a material in which the channels 103 are embedded.

Preferably, c defined as the minimum distance between the outer surface of a given channel and those of the channels adjacent thereto, the relationship ε<R/2, preferably ε<R/3, more preferably ε<R/4 applies, where ε=<εc> and where <εc> is average of the distance between adjacent channels 103 calculated over the plurality of channels 103.

As shown in FIGS. 1, 4, 9a, 9c and 10b, the filter 100 has interspaces between adjacent channels 103. The outer covering 111 substantially completely fills the interspaces between the adjacent channels 103. In other words, the first optically absorbing material that forms the outer covering 111 is interposed between the side surface of adjacent channels 103. The first optically absorbing material 111 is configured to reduce the passage of light through adjacent channels 103.

With reference to FIGS. 1 and 4, and considering cylindrical channels 103 with a substantially circular section, the interspaces between adjacent channels 103 are partially filled by the outer coverings 111. Preferably, the interspaces between adjacent channels 103 are filled with a second optically absorbing material 109, which is different from or the same as the first optically absorbing material, so as to prevent the passage of light between the first and the second surface outside the channels 103 through the interspaces between adjacent channels 103. Preferably, the absorption coefficient of the second optically absorbing material ensures an absorption of at least 50%, preferably 80%, more preferably 90% of the visible light for a thickness equal to ⅕ preferably 1/10 of the length of the channels 103.

According to the present invention, the length L of each channel 103 satisfies the following relationship:

$$L < A {L}_{0} \qquad [ 5 ]$$

$$where$$

$${L}_{0} ≡ 2 \frac{{n}_{a} R}{tan ( a sin \frac{sin {θ}_{0}}{{n}_{a}} )} \qquad [ 6 ]$$

Alternatively, for small values of the cut-off angle θ₀, i.e. for θ₀ less than 10°, the aforesaid relationship can be approximated as:

$${L}_{0} ≡ 2 \frac{{n}_{a} R}{{θ}_{0}} \qquad [ 7 ]$$

where nₐ is the value of the first refractive index, R is the average channel radius, θ₀ is a cut-off angle of the filter 100 due to the presence of the first and/or of the second optically absorbing material, and A is a constant equal to 5, or preferably equal to 3, or more preferably equal to 2, or even more preferably equal to 1.5, or even more preferably equal to 1.3.

Preferably, the length L of each channel satisfies the following relationship:

$$L > B {L}_{0} \qquad [ 8 ]$$

where B is a constant equal to ⅕, preferably equal to ⅓, more preferably equal to ½, even more preferably equal to 1/1.5, even more preferably equal to 1/1.3.

Preferably, considering a channel 103 having only one cladding 110b, the refractive index of the central core 110a and the refractive index of the first cladding 110b (i.e., the refractive index of the outermost cladding of the channel 103) satisfy the following relationship with a tolerance of more or less 50%, preferably more or less 20%:

$$\sqrt{{n}_{a}^{2} - {n}_{b}^{2}} ≃ sin ( {θ}_{0} ) \qquad [ 9 ]$$

wherein nₐ is the value of the first refractive index, np is the value of the second refractive index, and θ₀ is the cut-off angle of the filter 100.

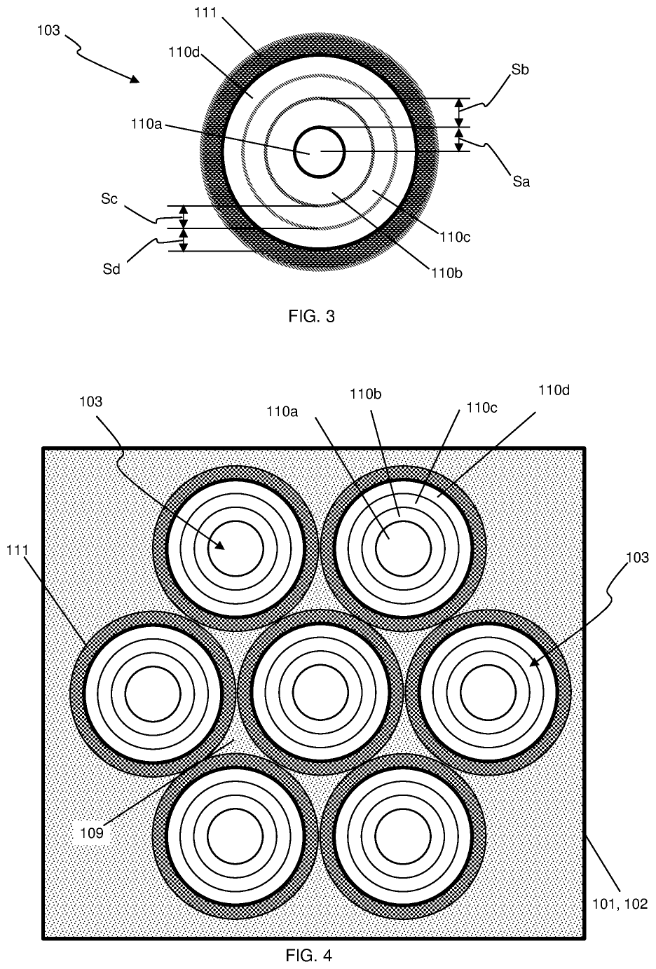

As anticipated above, according to embodiments of the present invention, each channel 103 comprises the central core 110a and a plurality of optical claddings 110b, . . . , 110d. For example, with reference to FIGS. 3 and 4, each channel 103 comprises:
a central core 110a having a first refractive index n1;
a first cladding 110b having a second refractive index n2, arranged outside and in contact with the outer surface of the central core 110a;
a second cladding 110c having a third refractive index n3, arranged outside and in contact with the outer surface of the first cladding 110b;
a third cladding 110d having a fourth refractive index n4, arranged outside and in contact with the outer surface of the second cladding 110c.

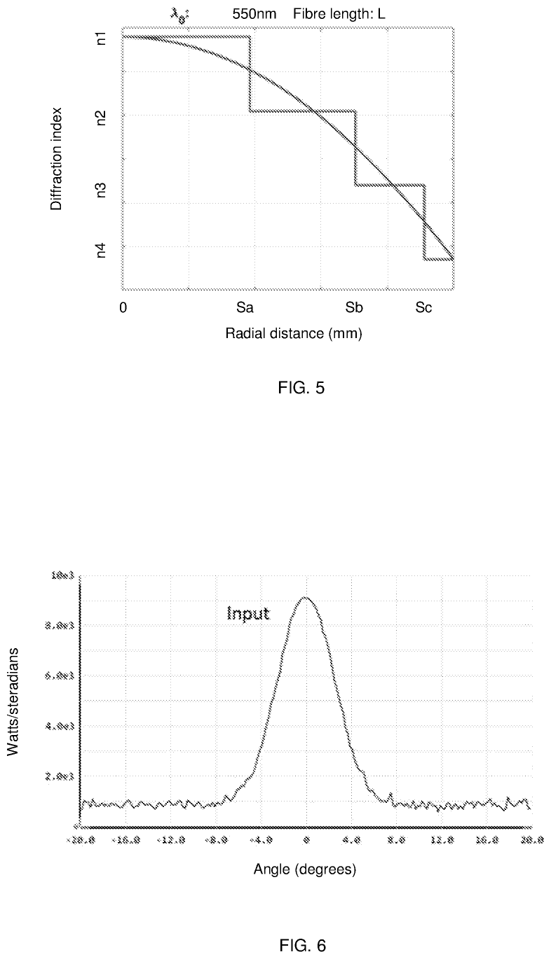

In particular, the first refractive index n1 is greater than the second refractive index n2; the second refractive index n2 is greater than the third refractive index n3; the third refractive index n3 is greater than the fourth refractive index n4. In other words, each channel 103 presents, starting from the centre of the channel 103 itself, a discrete and decreasing radial profile of the refractive index in a radially outward direction. In the volume of the central core 110a the maximum value of the refractive index is present, the value of the refractive index decreases moving from the central core 110a in a radially outward direction through the plurality of claddings 110b, . . . , 110d of the channel 103. A radial profile of the refractive index of an example channel 103 is shown in FIG. 5.

Preferably, the radial profile of the refractive index of each channel 103 approximates a parabolic profile. In other words, the number n−1 of the optical claddings 110b, . . . , 110n; the thickness of each cladding 110b, . . . , 110n; the thickness of the central core 110a; the refractive index of the central core 110a; and the refractive index of each cladding 110b, . . . , 110n are chosen so as to form a channel 103 having a radial profile of the discrete decreasing refractive index that approximates a parabolic profile. For example, such a parabolic profile can be represented by the following expression:

$$F ( r ) = {n}_{a} ( 1 - ( \frac{{g}^{2}}{2} {r}^{2} ) ) \qquad [ 10 ]$$

wherein F(r) is a function that approximates the radial profile of the discrete refractive index of the channel 103 as a function of the radial distance from the centre of the channel 103 itself, nₐ is the refractive index of the central core 110a, r is the radial distance from the centre of the channel 103 and g is a gradient coefficient that determines the optical power of the channel 103, and hence, the divergence of the beam it produces. In particular, considering a filter 100 having a cut-off angle θ₀, the gradient coefficient g is given by the following expression:

$$g = \frac{sin {θ}_{0}}{{n}_{a} R} \qquad [ 11 ]$$

where θ₀ is the cut-off angle of the filter 100, nₐ is the refractive index of the central core 110a of a respective channel 103, R is the average channel radius 103.

Note that the gradient coefficient g determines the optical power of the respective channel 103 and hence the divergence of the beam it produces. For example, a channel 103 configured to produce an angular profile of luminous intensity characterised by a cut-off angle substantially similar to the cut-off angle θ₀ of the filter 100 has, for example, a discrete refractive index profile that is best approximated by the parabolic function as expressed by wherein the gradient coefficient g is given by [11].

Preferably, the refractive index of the central core 110a and the refractive index of the third cladding 110d (i.e., the refractive index of the radially outermost cladding of the channel 103) satisfy the following relationship with a tolerance of more or less 50%, preferably more or less 20%:

$$\sqrt{{n}_{a}^{2} - {n}_{d}^{2}} ≃ sin ( {θ}_{0} ) \qquad [ 12 ]$$

wherein nₐ is the value of the first refractive index, nₐ is the value of the fourth refractive index, and θ₀ is the cut-off angle of the filter 100.

In other words, preferably, each channel 103 has a maximum refractive index nₘₐₓ (i.e., the refractive index of the central core 110a) and a minimum refractive index nₘᵢₙ (i.e., the refractive index of the radially outermost cladding of the channel 103) such refractive indices satisfy the following relationship with a tolerance of more or less 50%, preferably more or less 20%:

$$\sqrt{{n}_{max}^{2} - {n}_{min}^{2}} ≃ sin ( {θ}_{0} ) \qquad [ 13 ]$$

where θ₀ the cut-off angle of the filter 100.

Preferably, when each channel 103 comprises a plurality of claddings 110b, 110c, 110d, . . . , 110n the length L of each channel 103 further satisfies the following relationship:

$$L < A {L}_{1} \qquad [ 14 ]$$

$$where$$

$${L}_{1} ≡ \frac{π}{2} \frac{{n}_{a} R}{sin {θ}_{0}} \qquad [ 15 ]$$

alternatively, for small values of the cut-off angle θ₀, i.e. for values of the cut-off angle θ₀ smaller than 10°, the relationship can be approximated as follows:

$${L}_{1} ≡ \frac{π}{2} \frac{{n}_{a} R}{{θ}_{0}} \qquad [ 16 ]$$

where nₐ is the value of the refractive index of the central core 110a, R is the average channel radius, θ₀ is the cut-off angle of the filter 100 and A is a constant equal to 5, or preferably equal to 3, or more preferably equal to 2, or even more preferably equal to 1.5, or even more preferably equal to 1.3.

Preferably, when each channel 103 comprises a plurality of claddings 110b, 110c, 110d . . . , 110n the length L of each channel 103 satisfies the following relationship:

$$L > B {L}_{1} \qquad [ 17 ]$$

where B is a constant equal to ⅕, preferably equal to ⅓, more preferably equal to ½, even more preferably equal to 1/1.5, even more preferably equal to 1/1.3.

Preferably, each channel 103 is a channel having a positive optical power (or refractive power), i.e., a refractive optical element capable of focusing, at least partially, a light incident upon it. In particular, each channel 103 can be associated with at least one “object plane” and one “image plane”. Still more particularly, such “object plane” “image plane”, are both orthogonal to the channel 103 and such that, by positioning a substantially point-like light source in the object plane and on axis with the channel 103 itself, a luminance profile is produced in the image plane characterised by a maximum contrast and/or a maximum peak value, i.e. by a contrast and/or by a peak value respectively greater than the contrast and/or the peak value obtained in any other plane downstream the channel and in front of said image plane.

Preferably, also the optical filter 100 is a refractive optical element having optical power (or refractive power) greater than zero. Specifically, the optical filter 100 has at least one “object plane” and one “image plane”. More particularly, also the optical filter 100 is an optical element configured such that at least one “object plane” and one “image plane”, both parallel to the input and output surfaces of the filter, can be associated therewith. More specifically, the object plane and the image plane are such that by positioning a light source in the object plane, e.g., a source capable of producing in the object plane a pattern or a profile of luminance characterised by a contrast greater than 50%, e.g., a display or a transparency producing a pattern of pixels or of bright lines alternating with pixels or dark lines, it is produced in the image plane a luminance profile characterised by a maximum contrast, i.e., by a contrast greater than the contrast obtained in any other plane downstream the channel and in front of said image plane.

Preferably, the optical filter 100 has an image plane and an object plane that is/are placed at a distance (D1) from the first surface 101 and/or from the second surface 102 of the filter 100 measured along the direction of the longitudinal axis Y-Y given by the following relationship:

$${D}_{1} ≃ \frac{2 L}{{n}_{a} π} \qquad [ 18 ]$$

wherein:
L is the length L of a respective channel 103;
nₐ is the refractive index of the central core 110a and the relationship is verified with an accuracy of ±50%.

As anticipated above and shown in FIG. 3, each channel 103 comprises a central core 110a and a plurality of claddings 110b, . . . , 110d. The refractive index of the central core 110a and of each cladding 110b, . . . , 110d is chosen so as to obtain a discrete and decreasing radial profile of the refractive index approximating a parabolic curve given, for example, by the expression [10]. The Applicant observes that the radial profile of the refractive index can be modified by varying the average thickness Sb, . . . , Sd of each cladding 110b, . . . , 110d and the average radius Sa of the central core 110a, wherein the average is to be understood over the channel volume. In particular, in some embodiments, such as for example shown in FIGS. 3 and 4, the claddings 110b . . . , 110d of a respective channel 103 have the same average thickness Sb . . . , Sd. Alternatively, such as for example shown in FIG. 10a, the claddings 110b, . . . , 110h have different average thicknesses. Preferably, the central core 110a has an average radius Sa greater than the average thickness Sb, . . . , Sd of each cladding 110b, . . . , 110d.

Preferably, considering a respective channel 103 comprising a plurality of claddings 110b, 110c, 110d, such a plurality of claddings 110b, 110c, 110d have at least one intermediate cladding 110i (referring to FIG. 3 the intermediate cladding corresponds to the first cladding 110b or to the second cladding 110c) that is interposed between a radially innermost cladding 110i-1 or the central core 110a and a radially outermost cladding 110i+1. Considering the centre of that channel 103, defined as the point of the centre of gravity of a section of that channel 103, the following relationship applies:

$$\frac{n ( i - 1 ) - n ( i )}{d ( i ) - d ( i - 1 )} < \frac{n ( i ) - n ( i + 1 )}{d ( i + 1 ) - d ( i )} \qquad [ 19 ]$$

wherein:
n(i−1) is the refractive index of the innermost cladding 110i-1 or of the central core 110a,
n(i) is the refractive index of the intermediate cladding 110i,
n(i+1) is the refractive index of the adjacent outermost cladding 110i+1,
d(i−1) is an average distance from an axis parallel to the longitudinal axis Y-Y and passing through said centre of the respective channel 103 to a radially outer surface of said innermost cladding 110i-1 or of said central core 110a,
d(i) is an average distance from an axis parallel to the longitudinal axis Y-Y and passing through said centre of the respective channel 103 to a radially outer surface of said intermediate cladding 110i, and
d(i+1) is an average distance from an axis parallel to the longitudinal axis Y-Y and passing through said centre of the respective channel 103 to a radially outer surface of said adjacent outermost cladding 110i+1, where average is defined as the average over the azimuthal angle and over a section of the respective channel.

Preferably, these average distances are carried out on the different azimuthal angles and for a section of the respective channel 103.

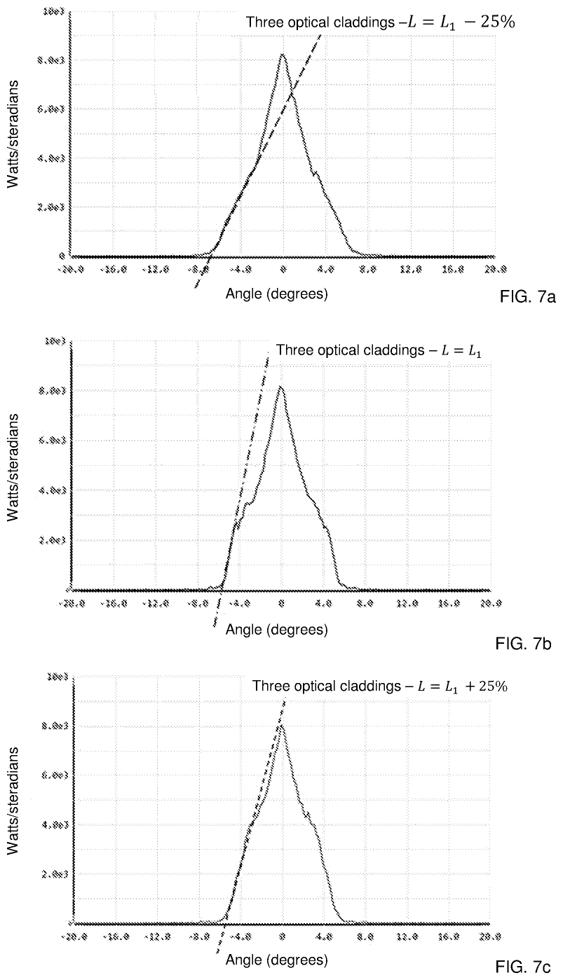

The Applicant observes that the length L of the channels 103 appreciably affects the behaviour of the filter 100. In particular, by defining a parameter, describing the characteristic of “sharp cut-off”, or maximum slope, or maximum contrast, i.e., the property of the angular profile of luminous intensity to express a rapid variation of intensity near the cut-off angle θ₀, as the inverse of the ratio of the difference between the average width of the angular profile of luminous intensity at values equal to 10% and 20% of the peak intensity to the average width calculated between the width of the angular profile of luminous intensity at values equal to 10% and 20% of the peak intensity, wherein the average is calculated over all azimuthal angles. That is, a parameter also called hereinafter as “steepness parameter S”, given by the following relationship:

$$S = \frac{2}{\frac{{θ}_{10 \%} - {θ}_{20 \%}}{{θ}_{10 \%} + {θ}_{20 \%}}} \qquad [ 20 ]$$

where
θ_{10%} is the average width calculated between the width of the angular profile of luminous intensity at values equal to 10%;
θ_{20%} is the average width calculated between the width of the angular profile of luminous intensity at values equal to 20%;
the angular profile with maximum slope or maximum contrast or maximum steepness parameter S is obtained for a length of the channel 103 equal to the nominal length L≃L1, i.e., equal to a length given by the following expression:

$$L ≃ {L}_{1} ≡ \frac{π}{2} \frac{{n}_{a} R}{{θ}_{0}} \qquad [ 21 ]$$

where nₐ is the value of the first refractive index, R is the average radius of a respective channel 103, θ₀ is the cut-off angle of the filter 100. For example, FIGS. 7a, 7b, 7c shows the variation of the profile of a light filtered by means of three filters 100, each of these filters 100 having a cut-off angle θ₀ (equal to approximately 5°). In particular, FIGS. 7a, 7b and 7c show the profile of a light filtered by means of:
a first filter 100 comprising channels 103 having a length L=L1−25% (FIG. 7a);
a second filter 100 comprising channels 103 having a length L=L1 (FIG. 7b); and
a third filter 100 comprising channels 103 having a length L=L1+25% (FIG. 7c).

In the example of FIGS. 7a, 7b and 7c, each filter 100 comprises a plurality of cylindrical channels 103 with circular section, which are parallel to each other and orthogonal to the surfaces of the respective filter 100 and immersed in a first optically absorbing material as described above. Each channel 103 comprising:
a cylindrical central core with circular section 110a having radius: 0.0192 m; refractive index: 1.4924;
a plurality of claddings having cylindrical outer surface with circular section, and in particular;
a first cladding 110a having outer radius: 0.0352 mm; refractive index: 1.4916;
a second cladding 110b having outer radius: 0.0455 mm, refractive index 1.4907;
a third cladding 110c having outer radius: 0.0500 mm, refractive index: 1.4898. By illuminating the first surface 101 of each of these filters 100 with an input light source having an angular profile of luminous intensity of Gaussian type, having a width at height equal to 1/e2 of the maximum equal to 5° and characterised by the presence of a constant background at all angles of intensity equal to 10% of the peak (FIG. 6) it is possible to obtain a filtered light at the output from the second surface 102 of the filter 100 having a different value of the steepness parameter S as a function of the length L of the channels 103 of the filter 100 considered. In particular, the steepness parameter S calculated for L=L1=1.34 mm is more than double that in the case L=L1+25%=1.68 mm, and at least 30% greater than in the case L=L1−25%=1.0 mm.

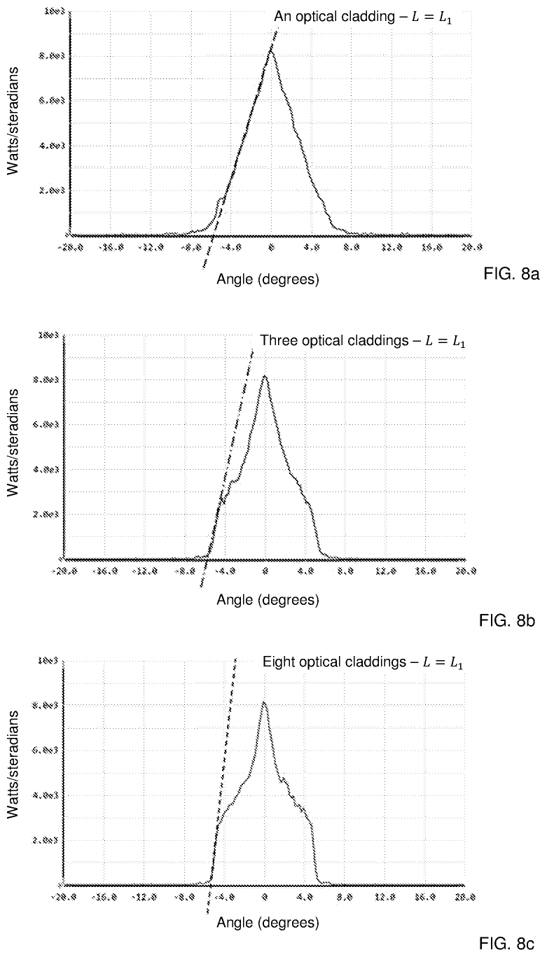

The Applicant further observes that the steepness parameter S also depends on the number n of optical claddings 110b, . . . , 110n arranged radially with respect to the central core 110a of each channel 103. In particular, a filter 100 having channels 103 comprising a plurality of claddings 110b, . . . , 110n wrapping the central core 110a of a respective channel 103 allows obtaining the maximum slope or maximum contrast of the light filtered by means of the optical filter 100. In particular, the higher the number N of the claddings 110b, . . . , 110n, the higher the contrast obtained. For example, as shown in FIGS. 8a, 8b and 8c, the variation of the profile of a filtered light by means of:
a first filter 100 comprising channels 103 having a single cladding 110b as described above (FIG. 8a);
a second filter 100 comprising channels 103 having three claddings 110b, . . . , 110d as described above (FIG. 8a);
a third filter 100 comprising channels 103 having eight claddings 110b, . . . , 110i as described above (FIG. 8a);
each filter 100 having the same cut-off angle θ₀ (equal to approximately) 5° and each filter 100 having the same thickness (i.e., the same length L as the channels 103), the third filter 100 comprising channels 103 comprising eight claddings has a higher contrast, i.e., a higher value of the steepness parameter S.

Still more particularly, the Applicant has calculated that a filter 100 comprising channels 103 having a plurality of claddings 110b, . . . 110n has a steepness parameter S equal to 5 or 6 times the values relating respectively to the case with only one cladding or to the case of a homogeneous channel (i.e. in the absence of claddings).

The Applicant further observes that it is possible to obtain a filter 100 having a further reduced length L of the channels 103. According to this variation, each channel 103 has a longitudinal axis Y-Y substantially perpendicular to the first surface 101 and to the second surface 102 of the filter 100. Furthermore, it is necessary to couple, at the first surface 101 or at the second surface 102 of the filter 100, a reflective surface (not shown).

Preferably, a channel 103 according to this embodiment has a length L equal to

$$L ≃ \frac{1}{2} {L}_{1} \qquad [ 22 ]$$

the relationship being verified with an accuracy of ±50%. Preferably, such an element of length L suitable for realising the optical filter 100 has, in the absence of the mirror, an image plane and an object plane. Specifically, the object plane and/or the image plane is/are placed at a distance D2 from the first surface 101 and/or from the second surface 102 given by the following relationship:

$${D}_{2} ≃ \frac{2.41 L}{{n}_{a}} \qquad [ 23 ]$$

wherein:
L is the length of a respective channel 103;
nₐ is the refractive index of the central core 110a, the relationship being verified with an accuracy of ±50%.

Referring again to FIGS. 1-4, according to an embodiment of the present invention, each channel 103 has a cylindrical conformation having a substantially circular section. Preferably, the channels 103 having a cylindrical conformation with a substantially circular section have bases having substantially the same area. In other words, the channels 103 are substantially equal to each other.

In other embodiments not illustrated, the channels 103 having a cylindrical conformation with a substantially circular section have bases having different areas, for example varying in a range between 3% and 30% of the average area of the channels 103 of the filter 100.

According to a further embodiment, the channels 103 conform to an extrusion solid with a non-circular section. The channels 103 have bases with areas that are not necessarily equal to each other. In such embodiments, for example, each channel 103 has a section having an effective radius Rc substantially different from the effective radius Rc of at least another channel 103 and/or has a shape substantially different from the shape of the section of at least another channel 103. Examples of such embodiments are shown in exemplary and non-limiting terms in FIGS. 9a-9b and 9c-9d.

Preferably, the standard deviation of the distribution of the effective rays Rc has a value comprised between 2% and 50%, preferably between 3% and 30%, more preferably between 4% and 20% of the value of the average radius R.

Preferably, as shown by way of non-limiting example in FIGS. 9a-9b and 9c-9d, the sections of the channels 103 in the plane orthogonal to the longitudinal axis are non-circular and have a substantially random orientation. In other words, the plurality of channels 103 is a plurality of “channels with averagely circular section”.

Preferably, as illustrated in FIGS. 9b and 9d, the figure obtained by translating, without rotating, and superimposing the sections or bases of each channel 103 at the respective centre of gravity of each section or base is a substantially circular or elliptical figure. In particular, such a substantially elliptical figure is characterised by a minor axis of the ellipse having length equal to at least 50%, preferably 60%, more preferably at least 70% of a major axis of the ellipse.

In greater detail, by assigning a value equal to 1 to the points belonging to each section of the channels 103 and a value equal to 0 elsewhere, the algebraic sum of the sections translated as described above produces a “sum distribution” of values, where these values vary between the value 0, for positions far from the common centre of gravity of the sections, to a maximum value equal to the number of the channels 103, for a position coincident or close to the common centre of gravity of the sections, and where the set of the points for which the sum of the sections produces a value greater than or equal to 50%, preferably 60%, or more preferably 70% of the maximum value defines a substantially circular or elliptical figure.

The Applicant has verified that in the case of an optical filter 100 having channels 103 having an averagely circular section, an angular profile of luminous intensity I(θ, ϕ) of the optical filter 100 when illuminated by a diffused light (i.e., by a light with a substantially uniform luminance profile, i.e. independent of the position, and isotropic, i.e. substantially Lambertian), results in being substantially independent or weakly dependent on ϕ, where θ is the polar angle with respect to the direction of the channels and ϕ is the azimuthal angle.

Particularly, the angular profile of luminous intensity I(θ, ϕ) of the optical filter 100 illuminated by a diffused light is such that the region in the space of the angular coordinates (θ, ϕ) outside of which I(θ, ϕ) assumes a value of less than 50%, preferably 70%, more preferably 80% of the peak value is substantially a cone with a circular or elliptical base characterised by a minor axis of the ellipse with length equal to at least 50%, preferably 60%, more preferably at least 70% of the major axis of the ellipse, or is a cone where the difference between the maximum and minimum polar angle is less than 30%, preferably 20%, more preferably 10% of the average polar angle, the average being carried out over the azimuthal angles.

Alternatively, the angular profile of luminous intensity I(θ, ϕ) of the optical filter 100 having channels with averagely circular section, illuminated by a diffused light, is such that the curve θ_{CM}(ϕ) delimiting the region in the space of the angular coordinates (θ, ϕ) outside of which I(θ, ϕ)<C Iₘₐₓ, where Iₘₐₓ is the maximum of the luminous intensity at all angles and C=0.5, more preferably C=0.3, more preferably C=0.2, is substantially a circumference, i.e. it is a closed curve such that the difference between the diameter of the circumference circumscribed to it and the diameter of the circumference inscribed to it is less than 50%, preferably 30%, more preferably 10% of the average value between the two diameters.

According to some embodiments of the optical filter 100 having channels 103 with averagely circular section, the angular profile of luminous intensity I(θ, ϕ) of the light produced by any portion of the optical filter 100 when illuminated by a diffused light results in being substantially independent or weakly dependent on the azimuthal angle ϕ, where said portion circumscribes a circle having a radius equal to 15 cm, preferably at least equal to 10 cm more preferably at least equal to 5 cm.

The Applicant observes that an optical filter 100 having channels with averagely circular section allows obtaining an image of a substantially circular sun despite the use of channels 103 that are different from each other and/or having a non-circular section.

In a first embodiment having a channel with averagely circular section, shown by way of non-limiting example in FIG. 9a, each channel 103 has a concave or convex non-polygonal section.

In a second embodiment having a channel with averagely circular section, shown by way of non-limiting example in FIG. 9c, each channel 103 has a simple and non-regular polygonal section. Preferably, according to this embodiment, the channels of the plurality of channels 103 have on average six side faces.

Preferably, when each channel 103 has a simple and non-regular polygonal section, the channels 103 have, on average, bases having four or five or six or seven or eight sides. Still more preferably, an average of the number of the sides of the base of each channel 103 is comprised between 4 and 8, and preferably is about 6.

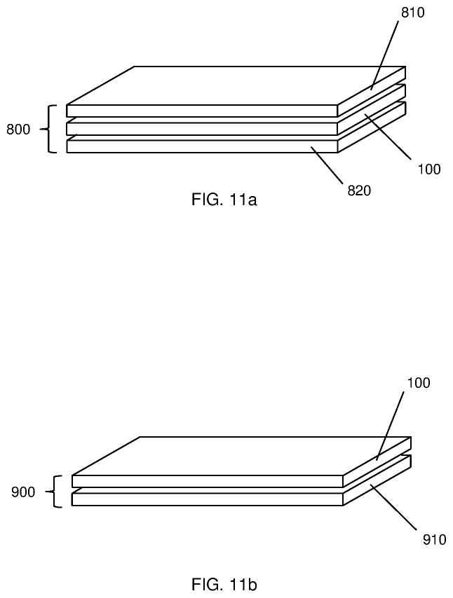

With reference to FIGS. 11a and 11b a first and second example of units 800,900 are illustrated that make use of an optical filter 100 according to the present invention, respectively a light reflective unit 800 and a chromatic unit 900.

The light reflective unit 800 of FIG. 11a comprises a reflective surface 810 positioned adjacent to, preferably in contact with, the first substantially flat surface 101 of the optical filter 100. In the illustrated embodiment, the light reflective unit 800 optionally comprises additionally a chromatic diffusion layer 820. Within the scope of the present invention, a light reflective unit 800 comprising a chromatic diffusion layer 820 is also referred to as a chromatic light reflective unit 1100. In the illustrated embodiment, the chromatic diffusion layer 820 has a back surface positioned adjacent, preferably in contact, to the second substantially flat surface 102 of the optical filter 100 and a front surface configured to be illuminated by incident light. Preferably, the chromatic diffusion layer 820 is a diffuser of the Rayleigh type, that is, it is a light diffuser comprising a plurality of substantially transparent nanoelements dispersed in a substantially transparent host material. In particular, the nanoelements and the host material have different refractive indexes. Preferably the ratio of the greater to the lesser of the refractive indices of the nanoelements and of the host material is greater than 1.02, preferably greater than 1.04, more preferably greater than 1.1, even more preferably greater than 1.5, even more preferably greater than 1.8. The chromatic diffusion layer 820 is configured such that the light reflective unit 800 produces a first direct light at polar angles lower than the cut-off angle θ₀ of the light reflective unit 800, having on average a first CCT, and a second diffused light at polar angles greater than the cut-off angle θ₀ of the light reflective unit 800, having on average a second CCT equal to at least 1.2 times, preferably 1.3 times, more preferably 1.5, even more preferably 1.8 times the first CCT, when the incident light is the standard illuminantor CIE E, and wherein average means the average over the azimuthal angles and over the polar angles respectively smaller and greater than θ₀, as well as over the light reflective unit 800. The term cut-off angle θ₀, or acceptance angle θ₀, of the light reflective unit 800 means the cut-off or acceptance angle associated with the path of the light that crosses the filter 100 in double step, being reflected by the reflective surface 810. It therefore differs from the cut-off angle θ₀, or acceptance angle θ₀, of the optical filter 100 included therein. With reference to the chromatic light reflective unit 1100, the cut-off angle θ₀, or the acceptance angle θ₀, is understood to mean the cut-off angle or the acceptance angle of the light reflective unit 800 measured after having suitably removed the chromatic diffusion layer 820, or after having suitably subtracted the contribution due to the light diffused by the chromatic diffusion layer 820 from the angular profile of luminous intensity of the light reflected by the light reflective unit 800.

Within the scope of the present description and the subsequent claims, for the quantification of the values of CCT, in general and for those indicated above, reference is made to an incident illumination coming from a white light source, for example a standard illuminator CIE E, which within the visible spectrum radiates equal energy and has a constant spectral power distribution (SPD). Although this is a theoretical reference, the standard illuminator CIE E is particularly suitable in the event of diffusion variability as a function of the wavelengths, as it has a uniform spectral weight with respect to all wavelengths.

Note that the chromatic diffusion properties are related to a relative refractive index between the nanoelements and the host material. Accordingly, the nanoelements may refer to solid particles, e.g., spherical nanoparticles and/or nanoclusters and/or nanocylinders and/or nanoelements having at least one nanometric dimension, where by nanometric dimension it is meant a dimension preferably on average lower than 300 nm, more preferably lower than 250 nm, even more preferably lower than 150 nm, as well as to optically equivalent nanometric elements in liquid or gaseous phase, such as generally inclusions in liquid or gaseous phase (for example nano-drops, nanovoids, nanoinclusions, nanobubbles, nanochannels etc.) which have nanometric dimensions and are incorporated into the host materials. Exemplary materials comprising inclusions in gaseous phase (nanovoids/nanopores) in a solid matrix include aerogels that are commonly formed by three-dimensional metal oxides (e.g. silica, alumina, iron oxide) or by an organic polymer (e.g. polyacrylates, polystyrene, polyurethanes and epoxides) that host solid pores (air/gas inclusions) with dimensions on nanometric scale. By way of example, materials comprising inclusions in liquid phase include liquid crystal (LC) phases with nanometric dimensions often referred to as a liquid phase that includes nanodroplets which are confined in a matrix that commonly may have a polymeric nature.

The chromatic diffusion layer 820 is made, for example, as a bulk panel, coating, paint, cladding film or the like.

The chromatic unit 900 in FIG. 11b comprises a chromatic diffusion layer 910 in turn comprising a surface positioned adjacent, preferably in contact, to the first substantially flat surface 101 or to the second substantially flat surface 102 of the optical filter 100 and configured to be illuminated by incident light. Preferably, in line with the foregoing about the chromatic diffusion layer 820 of the light reflective unit, the chromatic diffusion layer 910 is also a diffuser of the Rayleigh type, i.e., it is a light diffuser comprising a plurality of substantially transparent nanoelements dispersed in a substantially transparent matrix, wherein the nanoelements and the matrix have different refractive indexes. The chromatic diffusion layer 910 is configured such that the chromatic unit 900 produces a first direct light at polar angles lower than the cut-off angle θ₀ having on average a first CCT and a second diffused light at polar angles greater than the cut-off angle θ₀ having on average a second CCT equal to at least 1.2 times, preferably 1.3 times, more preferably 1.5, even more preferably 1.8 times the first CCT, when the incident light is the standard illuminator CIE E. Also in this case, the chromatic diffusion layer 910 is made, for example, as a bulk panel, coating, paint, cladding film or the like.

In different not illustrated embodiments, the chromatic diffusion layer 820 or, depending on the embodiment, the chromatic diffusion layer 910, is a diffused light generator comprising a plurality of LED sources laterally coupled to a substantially planar and transparent light guide and configured to generate a diffused light having a CCT with value equal to at least 1.2 times, preferably 1.3 times, more preferably 1.5 times, even more preferably 1.8 times the value of 5600 Kelvin.

According to a further aspect, the present invention provides a lighting unit.

Preferably, the lighting unit is a lighting unit of artificial light.

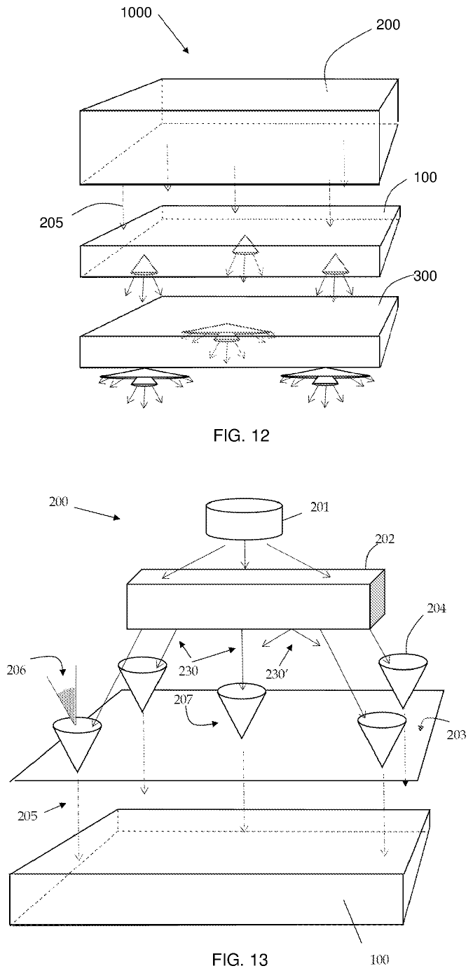

With reference to FIG. 12 a first example of a lighting unit of artificial light 1000 for reproducing sunlight using an optical filter 100 according to the present invention is illustrated. The lighting unit of artificial light 1000 comprises a direct light source 200 configured to emit visible light in a non-isotropic manner, along directions in a neighbourhood of a main direction 205, having a first colour correlated temperature or CCT. In some embodiments according to the invention, the direct light source 200 configured to emit visible light having a fixed CCT, for example a CCT greater than 5000 degrees Kelvin.

In other embodiments according to the invention, the direct light source 200 is configured to emit visible light having a variable CCT, for example a variable CCT in the range 1700-8000 degrees Kelvin.

An optical filter 100 according to the invention is placed downstream of the direct light source 200 with respect to the main direction 205. Preferably, the optical filter is oriented with respect to the direct light source 200 so as to have the longitudinal axis Y-Y substantially parallel to the main direction 205.

In the embodiment of FIG. 12 the optical filter 100 is positioned so as to have the first surface 101 and/or the second surface 102 oriented perpendicularly to the main direction 205. In other embodiments of the invention not illustrated, the optical filter 100 is positioned such that the normal to the first surface 101 and/or to the second surface 102 is inclined relative to the main direction 205 by an inclination angle α comprised between 5° and 80°, preferably between 10° and 70°, more preferably between 20° and 60°. In further embodiments of the invention, such as for example shown in FIG. 12, the lighting unit of artificial light 1000 further comprises a diffused light source 300 positioned downstream the optical filter 100 with respect to the main direction 205. The diffused light source 300 is configured to transmit, at least partially, the filtered light in output from the filter 100. Specifically, the diffused light source is configured to produce a diffused light component and a transmitted light component with an angular luminance profile similar to the angular luminance profile of the filtered light, i.e. characterised by the presence of a cut-off angle with value close to θ₀.

In some embodiments of the invention, the diffused light source 300 is configured to produce a light having a direct component having a colour correlated temperature or CCT that is at least 20% lower than the colour correlated temperature or CCT of the light produced by the direct light source 200. For example, the diffused light source 300 is a Rayleigh diffuser.

In other embodiments of the invention, the diffused light source 300 is configured to produce a light having a direct component having a CCT substantially identical to the CCT of the light produced by the direct light source 200. For example, the diffused light source 300 is a side-lit diffuser panel, i.e. lit laterally by a source other than the direct light source.

In some embodiments of the invention, the diffused light source 300 is further configured to produce a diffused light component, characterised by an angular luminance profile characterised by a divergence at least 2 times, preferably 3 times, more preferably 4 times greater than the divergence of the direct component, and/or by a colour correlated temperature or CCT at least 1.2 times, preferably 1.3 times, more preferably 1.5 times, even more preferably 1.8 times greater than the first CCT, and/or than a CCT equal to 5600 Kelvin.

In other embodiments of the invention, such as for example shown in FIG. 13, the direct light source 200 comprises a visible light emitter 201, an optical system 202 for collimating the light emitted by the visible light emitter, and a flat surface 203 for emitting the direct light. The optical system 202 produces a light 230 comprising a main component substantially collimated around a main direction 205 along directions preferably comprised within an emission cone 207 having a directrix along the main direction 205 and a half-opening 206 that is lower than 50 degrees, preferably lower than 30 degrees, more preferably lower than 10 degrees.

In other embodiments of the invention, the emission cone 207 has half-opening of less than 20 degrees, preferably less than 15 degrees, more preferably less than 8 degrees.

In some embodiments of the invention, such as the one shown by way of non-limiting example in FIG. 13, the light 230 produced by the optical system 202 also comprises a secondary or spurious component 230′, which propagates along directions outside the emission cone 207.

In some embodiments of the invention, such as for example shown in FIG. 13, the light produced by the optical system 202 reaches a flat emission surface 203 from different directions, i.e., the luminance of the light 230 produced by the optical system 202 on the flat emission surface 203 is not spatially uniform having an angular profile characterised by a peak for a direction that varies across the surface, for example it varies moving away from the main direction 205 the more the further away from the centre.

In other embodiments not illustrated, the luminance of the light 230 produced by the optical system 202 on the flat emission surface 203 has a peak for a direction that varies in a non-monotonous manner, for example periodically, across an emission surface.

In some embodiments of the invention, the optical system 202 is further configured such that the main component of the light 230 produced by it generates on a surface a substantially uniform luminance, for example, referring to FIG. 13, generates a substantially uniform luminance on the flat emission surface 203.

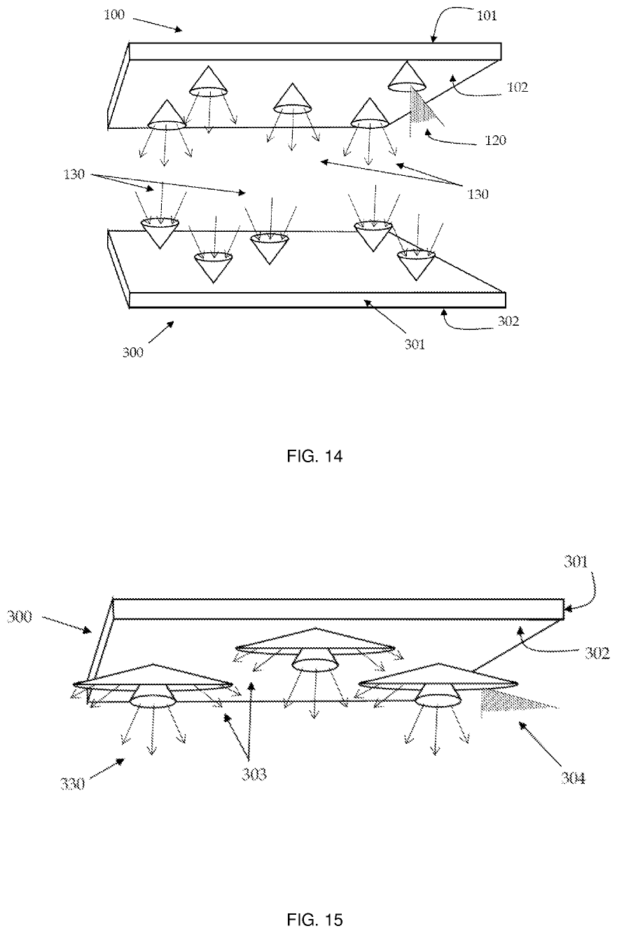

In some embodiments of the invention, like shown by way of non-limiting example in FIG. 14, the optical filter 100 is preferably sized in order to produce an acceptance cone with half-opening 120 that is substantially coincident with or greater than, for example 1.5, 2 or and 3 times greater than, the half-opening 206 of the emission cone 207 characterising the light 230 emitted by the visible light emitter 201 and collimated by the optical system 202, said half-opening 120 of the acceptance cone being equal to the cut-off angle θ₀ of the filter 100.

Within the scope of the present description and the appended claims, the expression “angular acceptance cone” is intended to mean the set of the directions forming an angle with respect to the longitudinal axis lower than or equal to the cut-off angle θ₀.

In some embodiments of the invention, like shown by way of non-limiting example in FIG. 15, the diffused light source 300 comprises a Rayleigh diffuser panel-like for example described in the International Patent Application No. WO 2009/156348 of the same Applicant. The Rayleigh diffuser panel preferably comprises a dispersion of nanoparticles in a polymer matrix, wherein the diameter of the nanoparticles, the number of nanoparticles per unit area, the refractive index of the nanoparticles and of the matrix in which they are dispersed are such as to enable the Rayleigh diffuser panel to produce on an emission surface 302, a diffused light 303 characterised by a colour correlated temperature or CCT equal to at least 1.2 times, preferably 1.3 times, more preferably 1.5 times greater than the first CCT, by a luminance profile with an angular half-opening of diffused light 304 of at least 60°, preferably of at least 70°, and a total luminous flux equal to at least 10% of the total luminous flux of the filtered light 130 impinging on the Rayleigh diffuser panel 301.

A different example of a lighting unit of artificial light 1000′ for reproducing sunlight using an optical filter 100 according to the present invention comprises a direct light source 700, which verifies all the properties of the direct light source 200 already mentioned with reference to FIGS. 12 and 13, and in particular it comprises a plurality of light sources 702 arranged on a substantially transparent surface 710, oriented so as to direct the light to one side of the surface 710, said light sources 702 being separated from each other by a minimum source distance ds. Preferably, the sources 702 are arranged equidistantly. Specifically, the transparent surface 710 is configured such that an observer can see through it a large portion of the background scene, i.e., he can see at least 50%, preferably 60%, more preferably at least 70% of the background scene, wherein the percentages are evaluated in terms of the solid angle subtending the scene or solid angle of view.

Each light source 702 of the plurality of light sources is arranged and configured to generate a beam of light 704 with a profile of source angular luminance having a peak along a main direction 705 and an angular half width at half height of the peak θs_HWHM, where the main direction 705 and the angular half width of source θs_HWHM are common to all the light sources of the plurality of light sources 702, and the main direction 705 is inclined with respect to the normal to the rest plane by an angle comprised between 0° and 80°, preferably between 0° and 70°, more preferably between 0° and 60°.

The lighting unit of artificial light 1000′ further comprises a chromatic light reflective unit 1100 that is substantially planar and with normal substantially parallel to the main direction 705. In particular, the chromatic light reflective unit 1100 is positioned in the space such that the light sources of the plurality of light sources 702 illuminate it substantially uniformly. For this purpose, for example, a minimum distance Dmin between each light source 702 and the chromatic light reflective unit 1100 measured along the main direction 705 fulfils the relationship: Dmin>0.5 ds tan(θs_HWHM), preferably Dmin>ds tan(θs_HWHM), more preferably Dmin>2 ds tan(θs_HWHM).

The chromatic light reflective unit 1100 comprises at least:
a reflective surface 1101 oriented towards the direct light source 700;
an optical filter 100 according to the present invention arranged in a position adjacent to the reflective surface 1101, preferably in contact with, the same 1101; and
a diffused light source 300 interposed between the optical filter 100 and the direct light source 700, in particular placed adjacent to the optical filter 100. In particular, the diffused light source 300 is preferably realised according to what is described above with reference to the embodiments of the FIGS. 12-15.

The optical filter 100 is preferably sized such that the assembly constituted by the reflective surface 1101 and the optical filter itself 100 produces an angular acceptance cone with half-opening 120 that is substantially coincident with or greater than, for example 1.5, 2 or 3 times greater than, a half-opening θs_HWHM of the emission cone 704 characterising the light emitted by each of the light sources 702. Further, as set forth above, the channels 103 of the optical filter 100 preferably have a length L substantially equal to

$$L ≃ \frac{1}{2} {L}_{1}$$

where this relationship is verified with an accuracy of ±50%.

Advantageously, the lighting unit of artificial light 1000′ so configured allows an observer positioned such that the direct light source 700 is interposed between the observer and the chromatic light reflective unit 1100 and that he observes said unit through the substantially transparent surface 710 of the source 700 to perceive, beyond this transparent surface 710, a uniform sky and a circular sun placed at infinite distance—in other words, a sun whose image follows the movement of the observer, for example, moving with the same distance or moving at the same speed if the observer moves in a plane perpendicular to the main direction 705. This effect takes place irrespective of whether the direct light source 700 is realised through a plurality of light sources 702 distributed on the transparent surface 710.

As further advantage, the lighting unit of artificial light 1000′ so configured produces an image of a round sun in sharp contrast to the sky even in conditions of a very bright outdoor environment because the light reflected by the reflective surface at angles greater than the cut-off angle θ₀ of the optical filter 100 is intercepted and substantially removed by said filter 100.

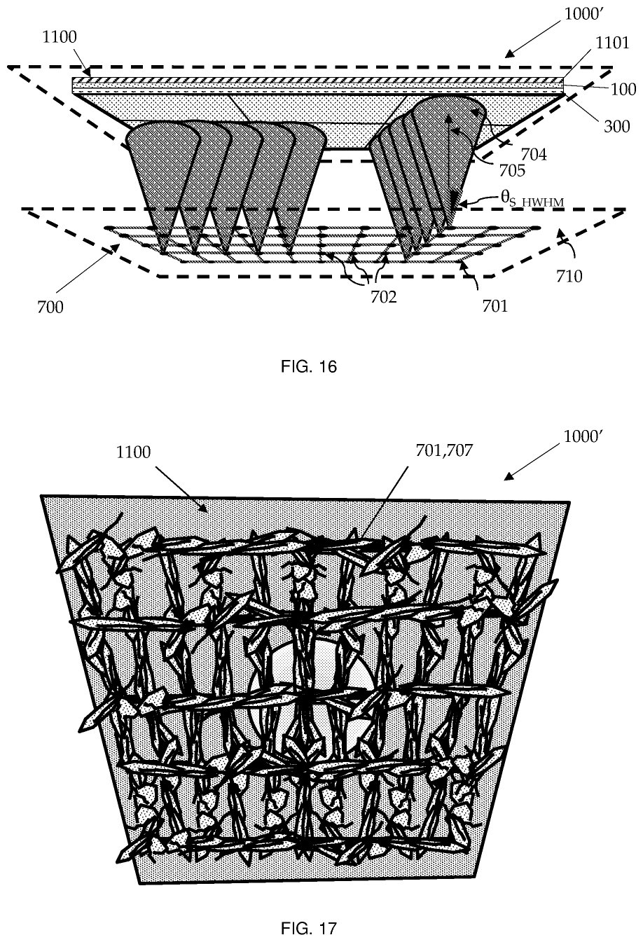

A first exemplary and non-limiting embodiment of the lighting unit of artificial light 1000′ is illustrated in FIG. 16. In such an embodiment, the direct light source comprises a support grid 701 which defines the transparent surface 710 and which supports the plurality of light sources 702. In particular, the grid 701 in FIG. 16 has a square pitch, but in a completely equivalent way it is possible to make a grid with a triangular, hexagonal or other regular pitch. In the embodiment of FIG. 16, the light sources 702 are arranged on the support grid 701 in a manner substantially equidistant to each other at the source distance ds. In particular, the light sources 702 are arranged on the vertices of the grid 701.

A second exemplary and non-limiting embodiment of the lighting unit of artificial light 1000′ is illustrated in FIG. 17. The lighting unit of artificial light 1000′ of FIG. 17 comprises in addition to what is described with reference to FIG. 16 a masking structure 707 positioned and configured so as to prevent the view of the light sources 702 from the observer of the chromatic light reflective unit 1100 through the support grid 701. In particular, the masking structure 707 is a pergola comprising a distribution 708 of live or artificial plants.

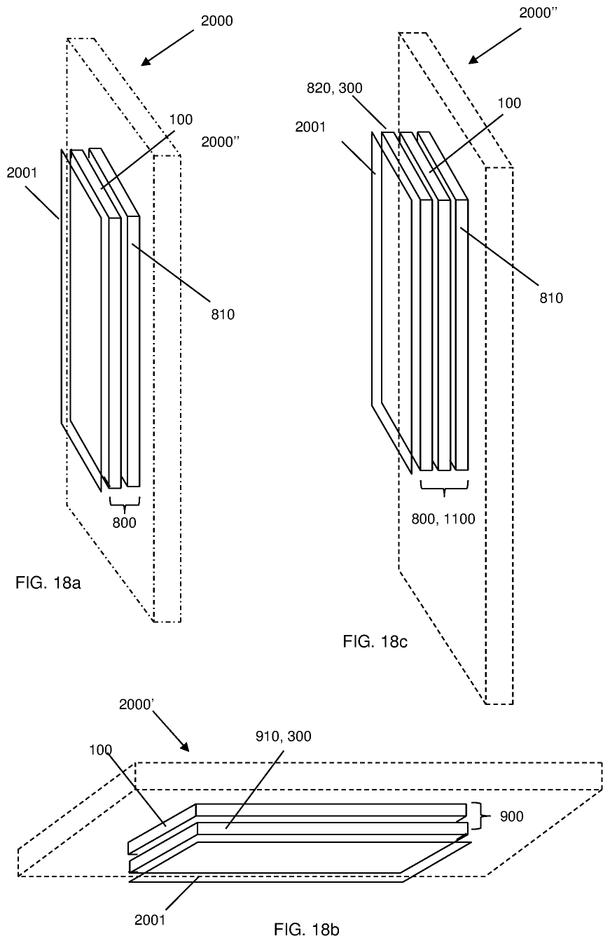

According to a different aspect of the present invention, the lighting unit is a lighting unit of natural light 2000,2000′,2000″ that is a lighting unit configured to produce a light originating from a natural light and/or obtained by processing a natural light. Exemplary embodiments of lighting units of natural light 2000,2000′, 2000″ according to the present invention are illustrated in FIGS. 18a-18c.

Within the scope of the present invention, the term “natural light” means light originally produced by the sun. By way of non-limiting example, natural light is, for example, direct sunlight, and/or sunlight transmitted, and/or reflected, and/or diffused, and/or refracted, and/or diffracted by a natural and/or artificial element, such as sunlight diffused by clouds, or fog, or mist, or the sky, or the moon, or by a wall.

Preferably, the lighting unit of natural light 2000,2000′,2000″ comprises a receiving surface 2001 configured to receive a natural light and an optical filter 100 according to the present invention, said optical filter having the first and/or second surface at least partially overlapping the receiving surface 2001.

Preferably, the lighting unit of natural light 2000′,2000″ comprises a diffused light source 300 configured to emit a diffused visible light 2101 having a colour correlated temperature or CCT at least 1.2 times, preferably 1.3 times, more preferably 1.5 times, even more preferably 1.8 times greater than a CCT of the natural light and/or than a CCT of 5600 Kelvin.

Preferably, the lighting unit of natural light 2000,2000′,2000″ comprises a receiving surface 2001 configured to receive a natural light and a light reflective unit 800 and/or a chromatic unit 900 and/or a chromatic light reflective unit 1100 according to the present invention. Preferably, at least one of the first or second surface of the optical filter 100 of the light reflective unit 800 and/or of the chromatic unit 900 and/or of the chromatic light reflective unit 1100 is at least partially overlapping the receiving surface 2001 of the lighting unit of natural light 2000,2000′,2000″.

In an alternative embodiment illustrated in FIG. 18a, the lighting unit of natural light 2000 comprises a light reflective unit 800 and is configured as a wall panel and/or as a ceiling panel.

In a different embodiment illustrated in FIG. 18b, the lighting unit of natural light 2000′ comprises a chromatic unit 900 and is configured as a skylight or as a window.

In a further embodiment illustrated in FIG. 18c, the lighting unit of natural light 2000″ comprises a chromatic light reflective unit 1100 and is configured as a wall panel and/or as a ceiling panel and/or as an element of a building façade.

Advantageously, the lighting unit of natural light 2000 comprising a light reflective unit 800 produces an image indefinitely of a circular sun with well-defined contours. For example, this occurs when it is illuminated by direct sunlight striking the light reflective unit 800 from a direction belonging to the acceptance cone of the light reflective unit 800, or when it is illuminated by a diffused natural light, contributing to the creation of a perception of infinite space. Advantageously, in the presence of direct sunlight, it is possible to significantly reduce the glare effect of the sun, which effectively prevents the observer from looking at the sun directly, without compromising the vision to infinity. To this purpose, it is sufficient to size the cut-off angle θ₀ such that the reflected image of the sun is perceived under a solid angle much greater than the solid angle subtending the image of the sun, i.e. 0.5°. For example, for 00=10°, the luminance of the reflected sun is attenuated by at least 1600 times than that of the natural sun, but without substantially compromising the contrast (as is the case with conventional diffused reflective surfaces).

Advantageously, the lighting unit of natural light 2000′ comprising a chromatic unit 900 comprising, for example, a chromatic diffusion layer 910 of the Rayleigh type, produces an image indefinitely of a sun in sharp contrast to a cloudless sky. This happens, for example, when it is illuminated by diffused white light. For example, if used as a skylight or window, it lights up and produces the effect of a clear day with the sun in the sky when outside the sky is instead grey and overcast, whereas it darkens by cutting off light in most of the directions of origin of direct sunlight when the day is sunny outside.

Advantageously, the lighting unit of natural light 2000″ comprising a chromatic light reflective unit 1100 comprising, for example, a chromatic diffusion layer 820 of the Rayleigh type, produces an image indefinitely of a sun in sharp contrast to a cloudless sky. This is the case, for example, when it is illuminated by a diffused white light, similar to the case of the lighting unit of natural light 2000′ comprising a chromatic unit 900. For example, if used as an element of a building façade, it can be configured to generate the image of a clear blue sky and a warmer coloured sun standing out sharply on the horizon in contrast to the sky when the day is completely grey and the sky overcast. Advantageously, in the presence instead of direct lighting by the sun, i.e. on a clear day, the lighting unit of natural light 2000″ comprising a chromatic light reflective unit 1100 diffuses in all directions a light having a CCT greater than the CCT of sunlight, e.g. a light having a CCT 2, or 3 or 4 times greater than the CCT of sunlight, thus recreating a light surface similar to the sky, e.g. recreating it on the illuminated façade.

1. An optical filter (100) comprising:
a first surface (101) substantially flat and a second surface (102) substantially flat and parallel to said first surface (101);
a plurality of optically transparent channels (103), parallel to each other, and made of at least one solid material, each channel (103) having an elongated conformation along a longitudinal axis (Y-Y) and extending between said first surface (103) and said second surface (102), each channel (103) having a respective side surface;
wherein each channel (103) comprises at least:
a central core (110a) having a first refractive index;
a first cladding (110b), which wraps the outer side surface of said central core (110b); said first cladding (110b) having a second refractive index smaller than said first refractive index;
a first optically absorbing material (111) interposed between the side surface of adjacent channels (103), wherein said first optically absorbing material (111) is configured to reduce the passage of light through adjacent channels (103);
wherein each channel (103) has a length (L) along said longitudinal axis (Y-Y) that satisfies the following relationship:
$$L < {AL}_{0}$$
$$where$$
$${L}_{0} ≡ 2 \frac{{n}_{a} R}{tan ( a sin \frac{sin {θ}_{0}}{{n}_{a}} )}$$
where nₐ is the value of said first refractive index, R is an average channel radius of the plurality of channels (103), θ₀ is a cut-off angle of the filter (100) and A is a constant equal to 5, or preferably equal to 3, or more preferably equal to 2, or even more preferably equal to 1.5, or even more preferably equal to 1.3.

2. The optical filter (100) according to claim 1, wherein each channel (103) comprises a plurality of claddings (110b, . . . , 110n), each cladding having a respective refractive index;
wherein each channel (103) has a discrete refractive index profile; said refractive index profile having a maximum at the volume of said central core (110a) and decreasing along a radially outward direction.

3. The optical filter (100) according to claim 2, wherein said length (L) further satisfies the following relationship:
$$L < {AL}_{1} ,$$
$$where$$
$${L}_{1} ≡ \frac{π}{2} \frac{{n}_{a} R}{sin {θ}_{0}}$$
where nₐ is said first refractive index, R is said average channel radius of the plurality of channels (103), θ₀ is said cut-off angle of the filter (100) and A is a constant equal to 5, or preferably equal to 3, or more preferably equal to 2, or even more preferably equal to 1.5, or even more preferably equal to 1.3.

4. The optical filter (100) according to any one of claim 2 or 3, wherein a centre of a respective channel (103) corresponding to the point of the centre of gravity of a section of the respective channel (103); and
each channel (103) comprises an intermediate cladding (110i) interposed between an innermost cladding (110i-1) or the central core (110a) and an adjacent outermost cladding (110i+1); said intermediate cladding (110i), said innermost cladding (110i-1) and said outermost cladding (110i+1) having a respective refractive index;
wherein for a respective channel (103) the following relationship applies:
$$\frac{n ( i - 1 ) - n ( i )}{d ( i ) - d ( i - 1 )} < \frac{n ( i ) - n ( i + 1 )}{d ( i + 1 ) - d ( i )}$$
where:
n(i−1) is the refractive index of said innermost cladding (110i-1) or of said central core (110a),
n(i) is the refractive index of said intermediate cladding (110i),
n(i+1) is the refractive index of said adjacent outermost cladding (110i+1),
d(i−1) is an average distance from an axis parallel to the longitudinal axis (Y-Y) and passing through said centre of the respective channel (103) to a radially outer surface of said innermost cladding (110i-1) or of said central core (110a),
d(i) is an average distance from an axis parallel to the longitudinal axis (Y-Y) and passing through said centre of the respective channel (103) to a radially outer surface of said intermediate cladding (110i), and
d(i+1) is an average distance from an axis parallel to the longitudinal axis (Y-Y) and passing through said centre of the respective channel (103) to a radially outer surface of said adjacent outermost cladding (110i+1).

5. The optical filter (100) according to claim 2-4, wherein said optical filter (100) has an image plane and an object plane;
said object plane and/or said image plane being placed either or both at a distance D1 from said first surface (101) and/or from said second surface (102) given by the following relationship:
$${D}_{1} ≃ \frac{2 L}{{n}_{a} π}$$
wherein:
L is the length (L) of a respective channel (103);
nₐ is the refractive index of said central core (110a).

6. The optical filter according to claim 2-4, wherein said optical filter (100) has an image plane and an object plane, said object plane and/or said image plane being placed either or both at a distance (D₂) from said first surface (101) and/or from said second surface (102) given by the following relationship:
$${D}_{2} ≃ \frac{2.41 L}{{n}_{a}}$$
wherein:
L is the length (L) of a respective channel (103);
nₐ is the refractive index of said central core (110a).

7. The optical filter (100) according to any one of the preceding claims wherein each channel (103) has a maximum refractive index nₘₐₓ and a minimum refractive index nₘᵢₙ, wherein said maximum refractive index nₘₐₓ corresponds to said first refractive index of said central core (110a) and said minimum refractive index nₘᵢₙ corresponds to a refractive index of the outermost cladding (110b/110n) of the channel (103);
wherein said maximum refractive index nₘₐₓ and said minimum refractive index nₘᵢₙ satisfy the following relationship with a tolerance of more or less 50%:
$$\sqrt{{n}_{max}^{2} - {n}_{min}^{2}} ≃ sin ( {θ}_{0} )$$
wherein θ₀ is said cut-off angle of the filter (100).

8. The filter (100) according to any one of the preceding claims, wherein each channel (103) has a substantially circular section.

9. The filter (100) according to any one of claims 1 to 7, wherein each channel (103) has a regular polygonal section.

10. The filter (100) according to any one of claims 1 to 7, wherein each channel (103) has a substantially elliptical section.

11. The filter (100) according to any one of claims 1 to 7, wherein each channel (103) has a non-polygonal concave or convex section.

12. The filter (100) according to any one of claims 1 to 7, wherein each channel (103) has an irregular polygonal section, preferably, an irregular convex polygonal section.

13. The filter (100) according to any one of the preceding claims wherein each channel (103) has a section having area and/or shape substantially different from an area and/or from a shape of a section of at least another channel (103).

14. The filter (100) according to any one of the preceding claims, wherein said central core (110a) of each channel (103) has a substantially circular section.

15. The filter (100) according to any one of the preceding claims, wherein said filter (100) comprises a plurality of statistically equivalent channels (103).

16. The filter (100) according to any one of the preceding claims, wherein the channels (103) have substantially randomly oriented sections in a plane orthogonal to the longitudinal axis (Y-Y).

17. The filter (100) according to any one of the preceding claims, wherein said plurality of channels (103) is a plurality of channels with averagely circular section.

18. The filter (100) according to any one of claims 2-17, wherein each channel (103) has a discrete refractive index profile approximating a parabolic profile.

19. The filter (100) according to any one of claims 4-18 wherein the following expression applies to each channel (103):
$$F ( r ) = {n}_{a} ( 1 - ( \frac{{g}^{2}}{2} {r}^{2} ) )$$
where F(r) is a function that approximates the discrete refractive index profile of the channel (103) as a function of a radial distance from the centre of the channel (103), nₐ is the refractive index of the central core 110a, r is the radial distance from the centre of the channel (103) and g is a gradient coefficient given by the following expression:
$$g = \frac{sin {θ}_{0}}{{n}_{a} R}$$
where θ₀ is the cut-off angle of the filter (100), nₐ is the refractive index of the central core (110a) of a respective channel (103), R is the average channel radius (103).

20. The optical filter (100) according to any one of claims 2-19, wherein each channel comprises a plurality of at least 3 claddings, preferably of at least 4 claddings, more preferably of at least 5 claddings, and even more preferably of at least 7 claddings.

21. Light reflective unit (800) comprising:
an optical filter (100) according to any one of claims 1 to 20; and
a reflective surface (810) positioned adjacent, preferably in contact, to the first substantially flat surface (101) of the optical filter (100).

22. Light reflective unit (800) according to claim 21, comprising a chromatic diffusion layer (820) comprising a rear surface positioned adjacent, preferably in contact, to the substantially flat second surface (102) of the optical filter (100) and a front surface configured to be illuminated by incident light,
wherein the chromatic diffusion layer (820) comprises a plurality of substantially transparent nanoelements dispersed in a substantially transparent matrix, the nanoelements and the matrix having different refractive indexes, and is configured such that the light reflective unit (800) produces a first direct light at a first CCT at polar angles lower than the cut-off angle (θ₀) and a second diffused light at a second CCT at polar angles greater than the cut-off angle (θ₀), with the second CCT being equal to at least 1.2 times, preferably 1.3 times or more preferably 1.5 times the first CCT, when the incident light is the standard illuminator CIE E.

23. Chromatic unit (900) comprising:
an optical filter (100) according to any one of claims 1 to 20; and
a chromatic diffusion layer (910) comprising a surface positioned adjacent, preferably in contact, to the first substantially flat surface (101) or to the second substantially flat surface (102) of the optical filter (100) and configured to be illuminated by incident light,
wherein the chromatic diffusion layer (910) comprises a plurality of substantially transparent nanoelements dispersed in a substantially transparent matrix, the nanoelements and the matrix having different refractive indexes, and is configured such that the chromatic unit (900) produces a first direct light at a first CCT at polar angles lower than the cut-off angle (θ₀) and a second diffused light at a second CCT at polar angles greater than the cut-off angle (θ₀), with the second CCT being equal to at least 1.2 times, preferably 1.3 times or more preferably 1.5 times the first CCT, when the incident light is the standard illuminator CIE E.

24. Lighting unit of artificial light (1000,1000′) for reproducing sunlight comprising:
a direct light source (200,700) configured to emit visible light in a non-isotropic manner; and
an optical filter (100) according to any one of claims 1 to 20, positioned downstream of the direct light source so that the input surface (101) of the optical filter is illuminated by the light emitted from the direct light source (200).

25. Lighting unit of artificial light (1000) according to claim 24 wherein, the direct light source (200)
emits visible light having a first colour correlated temperature or CCT;
comprises a visible light emitter (201), an optical system (202) for collimating the light emitted by the visible light emitter and a flat emission surface (203) emitting the direct light;
is configured to generate a light (230) mainly along directions comprised within an emission cone (207) having a directrix of the emission cone (205) perpendicular to the flat surface of direct light emission and having an angular half-opening of direct light (206), defined as the half-width of the angular luminance profile of the direct light source on the flat emission surface, less than 50 degrees, preferably less than 30 degrees, more preferably less than 10 degrees, where the semi-width is measured at a height equal to 0.5 times the peak value and the angular luminance profile is averaged over the spatial coordinates and the azimuthal coordinate,
and wherein the lighting unit of artificial light (1000) comprises a diffused light source (300) configured to emit a diffused visible light having a second colour correlated temperature or CCT equal to at least 1.2 times, preferably 1.3 times, more preferably 1.5 times greater than the first CCT.

26. Lighting unit of artificial light (1000) according to claim 24 wherein, the direct light source (700)
emits visible light having a first colour correlated temperature or CCT;
comprises a plurality of light sources (702) arranged on a substantially transparent surface (710), each light source (702) of the plurality of light sources being arranged and configured to generate a beam of light (704) with a profile of source angular luminance having a peak along a same main direction (705);
and wherein the lighting unit of artificial light (1000′) comprises a chromatic light reflective unit (1100) substantially planar and with normal substantially parallel to the main direction (705), said chromatic light reflective unit (1100) being positioned in the space so that the light sources of the plurality of light sources (702) illuminate it substantially uniformly,
wherein the optical filter (100) is comprised in said chromatic light reflective unit (1100) and said chromatic light reflective unit (1100) further comprises at least:
a reflective surface (1101) oriented towards the direct light source (700), wherein the optical filter (100) is positioned adjacent to the reflective surface (1101) and preferably in contact with the same (1101), and
a diffused light source (300) interposed between the optical filter (100) and the direct light source (700) and configured to emit a diffused visible light having a second colour correlated temperature or CCT equal to at least 1.2 times, preferably 1.3 times, more preferably 1.5 times, even more preferably 1.8 times the first CCT.

27. Natural lighting unit (2000,2000′,2000″) for reproducing sunlight comprising:
a receiving surface (2001) configured to receive a natural light and
an optical filter (100) according to any one of claims 1-20 having the first surface (101) or the second surface (102) at least partially overlapping the receiving surface (2001).

28. Natural lighting unit (2000′,2000″) according to claim 27 further comprising:
a diffused light source (300) configured to emit a diffused visible light having a colour correlated temperature or CCT at least 1.2 times, preferably 1.3 times, more preferably 1.5 times, even more preferably 1.8 times greater than a CCT of natural light and/or than a CCT equal to 5600 Kelvin; or
a chromatic diffusion layer (820,910) comprising a plurality of substantially transparent nanoelements dispersed in a substantially transparent matrix, the nanoelements and the matrix having different refractive indexes, and being configured such that the natural lighting unit (2000′,2000″) produces a first direct light at a first CCT at polar angles lower than the cut-off angle (θ₀) and a second diffused light at a second CCT at polar angles greater than the cut-off angle (θ₀), with the second CCT being equal to at least 1.2 times, preferably 1.3 times or more preferably 1.5 times the first CCT, when the incident light is the standard illuminator CIE E.
